(19) United States
(12) Patent Application Publication
(10) Pub. No.: US 2006/0195426 A1
(43) Pub. Date: Aug. 31, 2006

(54) Information management apparatus, information management method, and information management program

(76) Inventors: Daisuke Ishii, Kawasaki-shi (JP); Masaru Suzuki, Kawasaki-shi (JP); Yasuto Ishitani, Matsudo-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/235,165

(22) Filed: Sep. 27, 2005

(30) Foreign Application Priority Data
Feb. 25, 2005 (JP) 2005-051823

(51) Int. Cl. G06F 17/30

(52) U.S. Cl. 707/3

(57) ABSTRACT

A plurality of events are generated, each of which includes work information of a work having a work type and time information indicating at least when the work was done. The plurality of generated events is stored in an event storage device. The plurality of stored events is also arranged in an order corresponding to their time information, and is displayed in different display forms in accordance with the work type. When one of events is selected from the plurality of displayed events, the information associated with the work which the selected event has is displayed.

### CROSS-REFERENCE TO RELATED APPLICATIONS

This application is based upon and claims the benefit of priority from prior Japanese Patent Application No. 2005-051823, filed Feb. 25, 2005, the entire contents of which are incorporated herein by reference.

### BACKGROUND OF THE INVENTION

1. Field of the Invention

The present invention relates to the management of event information indicating the log of operations performed by a user in an information processing apparatus and, more particularly, to an information management apparatus, information management method, and information management program which, for example, generate, store, and display event information comprising information associated with operations performed by the user, e.g., searching for, browsing, and editing documents, and the meta-information of the operations, e.g., times and operation types.

2. Description of the Related Art

With the spread of personal computers and an increase in the use of the Internet, end users handle, on computers, various and a large quantity of documents which exist in various places. Such documents exist in, for example, the storage devices (local file systems) of the computers of users and a network formed by computers connected through a communication network. There are also documents and the like which are generated by digitizing printed matter in the real world using a scanner apparatus and OCR (Optical Character Reader).

These documents exist in various forms. Documents are handled by software called an application on a computer. Such documents have different forms in accordance with the applications which handle them. For example, such forms include the text form in which documents are formed from readable character information and are browsed and edited by an application called a text editor, the HTML (Hyper Text Markup Language) form for documents which are communicated on WWW (World Wide Web) and are browsed by an application called a browser, and the e-mail form in which documents are transmitted/received on a network in accordance with a protocol called SMTP (Simple Mail Transfer Protocol) or POP (Post Office Protocol) and browsed and edited by an application called a “mailer”.

When a large quantity of documents having such various forms exist in the local file system of an information processing apparatus, the user generally arranges and manages such documents in accordance with the tree structure of the file system. Recently, as the capacities of storage devices such as hard disks have increased, the quantity of documents stored has increased, and the tree structures have become excessively complicated. This makes it difficult for users to intuitively grasp the tree structures.

The user generally searches for a necessary document by using a search means. In WWW, a server apparatus called a search engine exists, which allows a search through a browser. An OS (Operating System) such as Windows XP (trademark) or Mac OS X (trademark) has a means for searching for a document in the local file system. An application such as a mailer often has a search means for e-mail documents and the like to be handled in the application.

A current search means is generally based on keyword search operation in which the user designates a keyword contained in a required document as a query. In keyword search operation, however, the user must designate a keyword by trial and error to obtain a document. In addition, there are various kinds of keyword search mechanisms in accordance with the locations of documents and their forms. The user must perform, for example, the operation of finding or switching search means according to need.

Under the circumstances, search means based on meta-information, such as Spotlight (trademark) available from Apple (trademark) and MSN search (trademark) available from Microsoft (trademark) have been developed. In such a search means, each document has content summary information, application-dependent information, or the like as meta-information, and an API (Application Program Interface) for searching for meta-information on the OS level is prepared, thereby allowing various kinds of searches to be made for documents in the local storage altogether.

Japanese Patent Application No. 11-108535 discloses an information processing method and information processing apparatus which can store documents upon associating time information with each document. In Japanese Patent Application No. 11-108535, it is described that when a user sets a desired date, a document corresponding to the time information is reproduced.

U.S. Pat. No. 6,738,973 also discloses a method of presenting an access log associated with a document. In U.S. Pat. No. 6,738,973, it is described that access log icons are presented near document icons and the like on the basis of the access logs of sequentially recorded documents, thereby allowing the user to intuitively grasp a reference log or update log.

In “Toshiyuki Masui, Koji Tsukada, and Akira Takabayashi, Information Navigation by Neighbor Hopping, Toshiyuki Masui (editor), Interactive System and Software XI, 2003”, a technique called “neighbor hopping” of searching for documents highly relevant to a given document is disclosed. In this reference, a system is described in which when a user pays attention to a given document, documents and the like which are relevant in content to the given document, have the same attribute as that of the given document, and are stored at locations on a file system which are near the location of the given document are retrieved and presented, and associative searches can be easily performed by repetitive clicking operation.

In conventional document management, as a file system storing documents becomes excessively complicated and increases in size, and documents exist in a wide network space, problems arise, including taking a long time for a user to search for a document, not allowing the user to intuitively browse documents, and scattering related documents.

In addition, as the user proceeds with work on a computer, it becomes more difficult for the user to grasp the process of work, because of the above problems, e.g., taking much time and labor to search for documents.

### BRIEF SUMMARY OF THE INVENTION

It is an object of the present invention to provide an information management apparatus, information management method, and information management program which manage information associated with past work and the meta-information of the work altogether in accordance with event information, and can easily obtain necessary information on the basis of event information display.

According to an aspect of the present invention, there is provided an information management apparatus that manages information for displaying on a display device, comprising: an event generation device configured to generate a plurality of events each including work information of a work having a work type and time information indicating at least when the work was done; an event storage device to store the plurality of events generated by the event generation device; an event display control device connectable to the display device, and configured to arrange the plurality of events in an order corresponding to their time information, and to control the display device to display the events in different display forms in accordance with the work type; an event selection device configured to select an event from the plurality of events displayed by the display device controlled by the event display control device; and an information display control device connectable to the display device and configured to control the display device to display the work information which the selected event has.

### BRIEF DESCRIPTION OF THE SEVERAL VIEWS OF THE DRAWING

FIG. 1 is a block diagram showing an information management apparatus according to an embodiment of the present invention;

FIG. 2 is a flowchart showing a processing sequence in the information management apparatus according to the embodiment of the present invention;

FIG. 3 is a view showing an example of a window displayed on a screen;

FIG. 4 is a view showing an example of document information in the XHTML form;

FIG. 5 is a view showing an example of search result list display in the window;

FIG. 6 is a view for explaining the componentization of a document;

FIG. 7 is a view showing an example of componentized document information;

FIG. 8A is a view showing an example of search-type event information;

FIG. 8B is a view showing an example of display-type event information;

FIG. 8C is a view showing an example of componentization-type event information;

FIG. 8D is a view showing an example of scrap-type event information;

FIGS. 9A to 9E are views each showing an example of event information in a table form which is stored in a relational database;

FIG. 10 is a flowchart for explaining a processing sequence for the generation of event information;

FIGS. 11A to 11C are views showing examples of display of event information simplified at different granularities by an event display unit;

FIG. 12 is a flowchart for explaining event display control processing performed by an event display control unit and the event display unit;

FIG. 13 is a view showing an example of the simplification (granularity “1”) of event information;

FIG. 14 is a view showing an example of the simplification (granularity “2”) of event information;

FIGS. 15A and 15B are views each showing a display example of the event display unit in a window;

FIG. 16 is a view showing a context menu displayed on the event display unit;

FIG. 17 is a flowchart for explaining the operation of displaying information associated with work which selected event information has;

FIG. 18 is a flowchart for explaining processing to be performed when a search is made for event information on the basis of display;

FIG. 19 is a view showing a window to be displayed when a local search and scraping operation are performed;

FIG. 20A is a view showing an example of event information for a local search;

FIG. 20B is a view showing an example of display-type event information;

FIG. 20C is a view showing an example of a componentization-type event information;

FIG. 20D is a view showing an example of scrap-type event information;

FIG. 21 is a view showing a window to be displayed when a WWW search is performed on the basis of a componentized document;

FIG. 22 is a view showing a window to be displayed when map information is to be scraped;

FIG. 23 is a view showing a window to be displayed when a search is performed by a route search site;

FIG. 24 is a view showing a window to be displayed when the route information retrieved by the route search site is scraped;

FIG. 25 is a view showing a window to be displayed when a search is made for past event information by scrolling operation;

FIG. 26 is a view showing a window to be displayed when a search is made for past event information after event information is simplified and displayed;

FIG. 27 is a view showing a window to be displayed when a WWW search is performed on the basis of a componentized document;

FIG. 28 is a view showing a window to be displayed when a search result is obtained from a WWW search engine;

FIG. 29 is a view showing a window to be displayed when information on a Web site is scraped;

FIG. 30 is a view showing a window to be displayed when the display form of an event display unit is switched to a calendar display form;

FIG. 31 is a view showing a window to be displayed when a scrap sheet is set as a TODO-type event;

FIG. 32 is a view showing a window to be displayed when a generated scrap sheet is set as a TODO-type event;

FIG. 33 is a view showing an example of TODO-type event information;

FIG. 34 is a view showing a window to be displayed when the generation of a scrap sheet is terminated;

FIG. 35 is a view showing a window to be displayed when the generation of a scrap sheet is terminated and a new scrap sheet is generated;

FIG. 36 is a view showing an example of scrap-type event information representing the generation of a new scrap sheet;

FIG. 37 is a view showing a window to be displayed when a scrap sheet generated in the past is displayed on the basis of set TODO-type event information;

FIG. 38 is a view showing a window to be displayed when a search is made to a past mail document by a local search;

FIG. 39 is a view showing a window to be displayed when event information obtained by componentizing a displayed document is extracted;

FIG. 40 is view showing a window to be displayed when a scrap sheet is displayed on the basis of scrap-type event information located near componentization-type event information;

FIG. 41 is a view showing a window to be displayed when scraping is newly performed;

FIG. 42 is a view showing a window to be displayed when a scrap event is extracted from a scrap component;

FIG. 43 is a view showing a window to be displayed when a search is performed again by using a search query display event on a route search site located near a route information display event;

FIG. 44 is a view showing a window to be displayed when a scrap event is extracted from a scrap component;

FIG. 45 is a view showing a window to be displayed when a search result display event of a Web search engine located near a document display event on a Web site is used to display a document on another Web site;

FIG. 46 is a view showing a window to be displayed when the latest document on a Web site is displayed;

FIG. 47 is a view showing a window to be displayed when a search is made for a memo written for a check made in the past;

FIG. 48 is a view showing a window to be displayed when a memo document is scraped; and

FIG. 49 is a view showing a window to be displayed when a search is made for a related document from a scrap component.

### DETAILED DESCRIPTION OF THE INVENTION

An embodiment of the present invention will be described below with reference to the views of the accompanying drawing.

An embodiment of the present invention is directed to a document management apparatus which manages document information to allow a user to intuitively and properly perform work such as searching for a document, performing browse display, generating a componentized document, and generating a scrap sheet on the basis of event display.

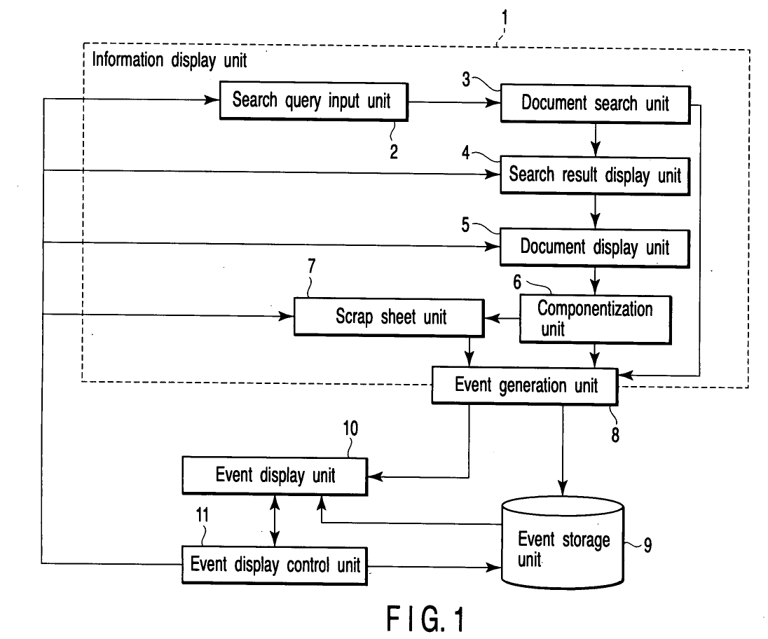

FIG. 1 is a block diagram showing an information management apparatus according to an embodiment of the present invention. This information management apparatus comprises an information display unit 1, event generation unit 8, event storage unit 9, event display unit 10, and event display control unit 11. The information display unit 1 comprises a search query input unit 2, document search unit 3, search result display unit 4, document display unit 5, componentization unit 6, and scrap sheet unit 7. Referring to FIG. 1, part of the event generation unit 8 is included in the information display unit 1.

The present invention can be implemented as a program which causes a computer to function as an information management apparatus having such an arrangement. In this case, the program according to the present invention is stored in a program storage device in the computer. The program storage device is formed from a nonvolatile semiconductor storage device, a magnetic disk device, or the like. When the above program is loaded into a random access memory (RAM) under the control of a CPU (not shown) and executed by the CPU, the computer can be made to function as an information management apparatus according to the present invention. Note that an operating system which manages various computer resources and provides a graphical user interface (GUI) and the like is also installed in this computer.

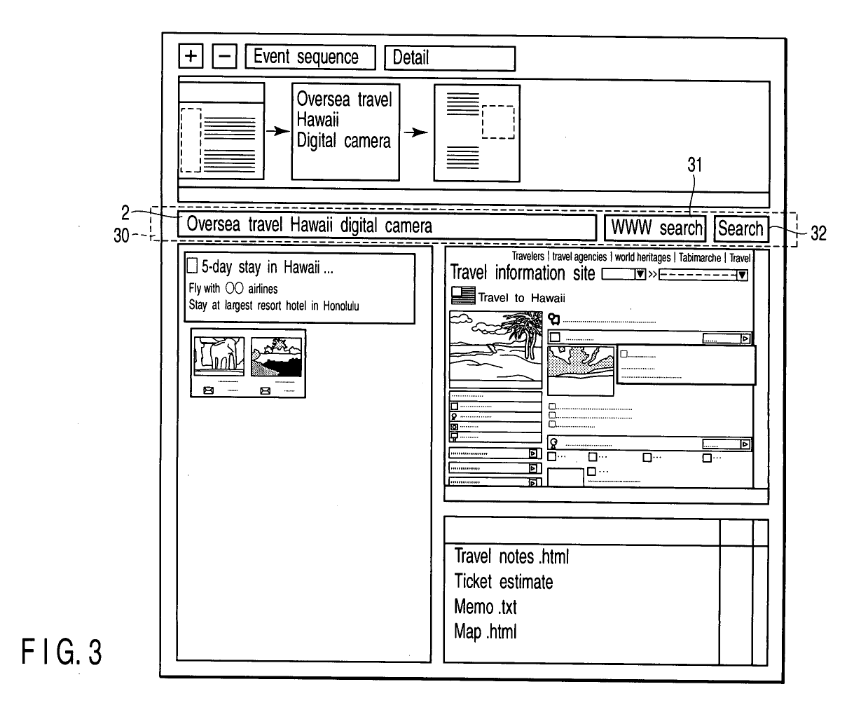

In this embodiment, in a state wherein the computer is started, i.e., the switch of the computer hardware is turned on to activate the OS, and software for document management processing is activated, a window like that shown in FIG. 3 is displayed on the screen of a CRT (Cathode Ray Tube) or the like connected to the computer. As the user interactively performs input operation through this window by using a mouse, a keyboard, and the like, the processing proceeds.

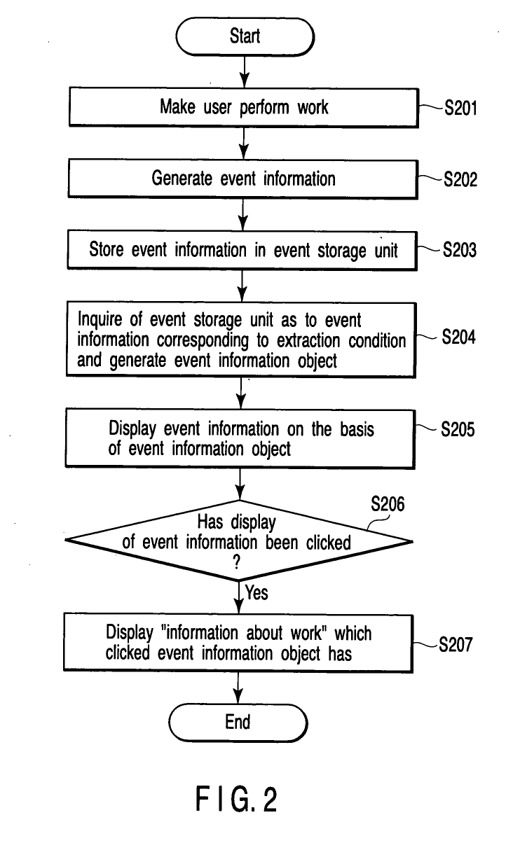

FIG. 2 is a flowchart schematically showing a processing sequence in the information management apparatus according to this embodiment. First of all, when the user performs work (step S201), the information management apparatus generates event information (step S202), and stores the generated event information in the event storage unit 9 (step S203). The event display control unit 11 inquires of the event storage unit 9 as to event information corresponding to a filtering condition, and generates event information object on the basis of the inquiry (step S204). The event display unit 10 displays the generated event information object (step S205). In this case, the information management apparatus determines whether or not input operation is performed, e.g., the displayed event information is clicked by the user (step S206). If input operation is performed, the information management apparatus displays “information about work” which the clicked event information has (step S207).

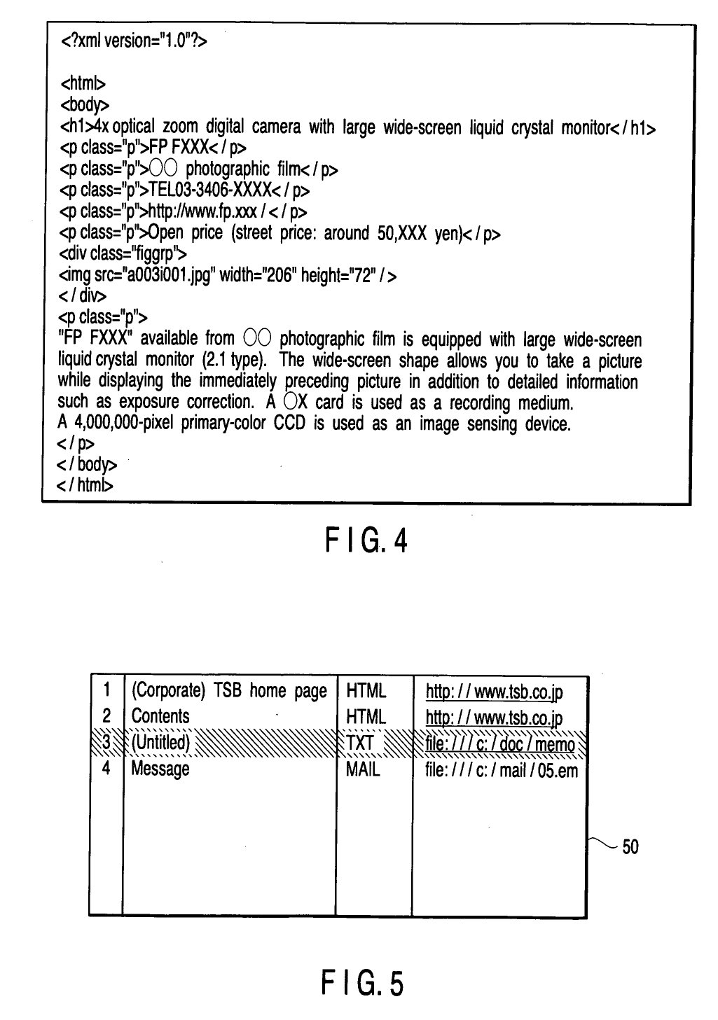

In this embodiment, document information based on the XML (extensible Markup Language) form is handled. FIG. 4 shows an example of document information. Assume that document information is described by using an XML vocabulary called XHTML (extensible HyperText Markup Language) in particular. Note that the present invention is not limited to structured documents in any specific form. Information in the HTML form on WWW is handled upon being converted into XHTML information when the document display unit 5 (to be described later) displays it.

Information in the text form stored in a storage in the computer and mail information handled by a mail application can be stored in the local database in this embodiment by using a program called “crawler”.

The search query input unit 2 accepts a search query input from the user. The search query input unit 2 is provided in a panel 30 in FIG. 3 on the screen of a CRT or the like. The user inputs a word as a keyword in a character string input area in the panel 30. A plurality of keywords may be input upon being delimited with blank characters. Using, for example, a character string enclosed by escape characters “[” and “]” like “[mail]” as a keyword as well as arbitrary character string information such as “Hawaii” and “travel” can make an expression for limiting targets to documents in the mail form.

A combo box 31 included in a search strategy selection area in the panel 30 is used to display and change information called search strategy. When the user performs clicking operation on the display of the combo box 31, a menu which prompts the user to select a search strategy is displayed. The user then selects a search strategy from this display and performs clicking operation. As a result, a new search strategy is selected. The search strategy is information indicating which kind of search is performed by using which means when there is a plurality of search means.

This embodiment comprises a WWW search strategy, local search strategy, and related document search strategy as search strategies. According to the WWW search strategy, a search engine on WWW is used to search for a document on WWW. According to the local search strategy, a database on a local machine is used to search for a document stored therein. According to the related document search strategy, event information is used to search for documents deeply relevant to the document displayed on the document display unit 5.

The user can notify the search query input unit 2 of the start of search processing by pressing a search (execution) button 32 in the panel 30. In this case, the search query input unit 2 inputs a search query and search strategy to the document search unit 3. The search query input unit 2 acquires the character string information in the text input area or the information in the document display unit 5 and scrap sheet, and input the information as a search query to the document search unit 3. In addition, the search query input unit 2 obtains a search strategy in accordance with the input state of the search strategy selection area, and inputs it to the document search unit 3.

The document search unit 3 searches for a document by using an external search means such as a search engine on WWW or a database management system on the local machine. Which means is to be used for a search depends on which search strategy is designated. First of all, the search query string is analyzed to obtain keywords from which delimiter characters are removed. A search is executed on the basis of the obtained search queries to obtain pieces of document reference information ordered according to the degrees of identification with the search queries. Document reference information is, for example, a URI (Uniform Resource Identifier). The pieces of document reference information are input to the search result display unit 4.

The search result display unit 4 displays a search result list 50 obtained by the document search unit 3. From the search result list 50, user can select a document to be displayed on the document display unit 5. On the basis of the pieces of input document reference information, the order of search, the types of documents, URIs, and the like are displayed, as shown in FIG. 5. The user selects one document from the search result list 50, and performs double-clicking operation on the corresponding display. In response to this operation, the search result display unit 4 inputs the selected document reference information to the document display unit 5.

The document display unit 5 obtains document data on the basis of the input document reference information, and display the information on the screen. The document display unit 5 accepts input operation by the user who has used the mouse. When a partial area on the display is designated by dragging with the mouse, the designated part of the document can be input to the componentization unit 6 to be componentized. With respect to the componentized area, display operation is performed to indicate that the area has been componentized. The user can scrap the componentized document by dragging the componentized document from the display of the componentized document onto the display of the scrap sheet unit 7.

The componentization unit 6 performs componentization processing for documents. A document generated by componentization processing will be referred to as a “componentized document”. A document and information indicating partial area of the document are to be inputted to the componentization unit 6. For example, the latter information indicating the part can be position information indicating a section in the document as a code sequence. For example, the document information shown in FIG. 4 is input, together with information comprising numerical values indicating two positions and a character “-”, like “24-120”, which indicates a section between the 24th character and the 120th character when counted from the beginning of the document information.

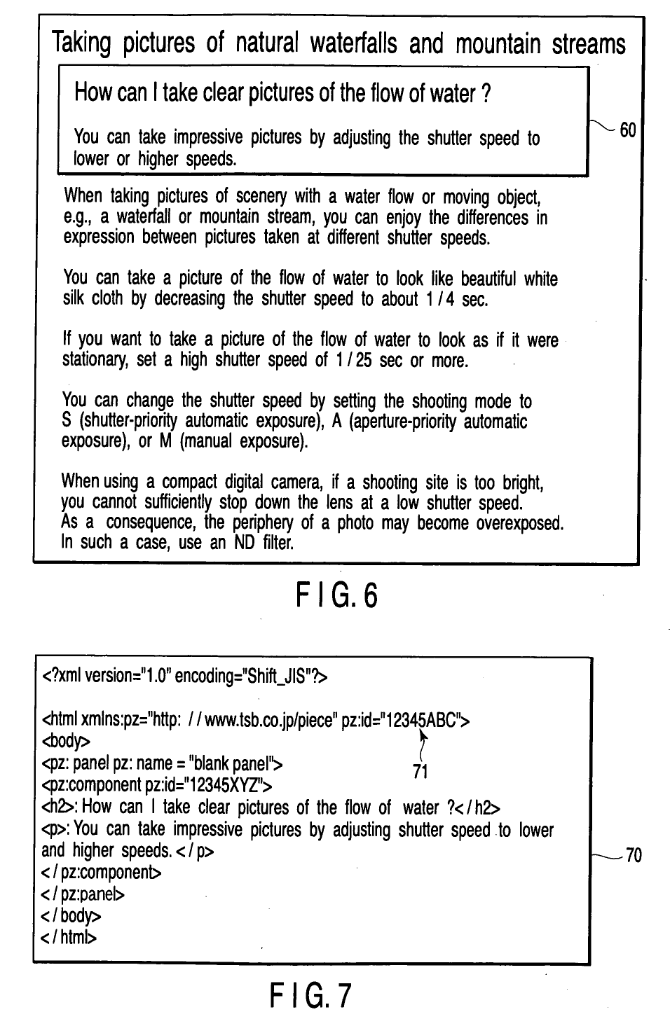

The information of a componentized document is generated by extracting part of an original document and adding information indicating the partial area of an original document. In this embodiment, information such as an ID attribute, panel tag, and component tag is added. In the above case, on the basis of the provided information, a part 60 shown in FIG. 6 is extracted, and componentized document information 70 like that shown in FIG. 7 is generated. Component information based on XML format is added to the componentized document information 70. “<pz:panel pz:name=“blank panel”>” and “</pz:panel>” correspond to information called panel tags, and “<pz:component pz:id=“12345XYZ”>” and “</pz:component>” correspond to information called component tags. In the componentized document information 70, a unique character string with respect to all componentized documents in the computer is set as additional information called an ID. Information 71 “pz:id=“12345ABC”” in FIG. 7 represents an ID.

The scrap sheet unit 7 receives a componentized document from the document display unit 5 and generates a scrap sheet. A scrap sheet is a document corresponding to a componentized document set including at least one componentized document. Componentized documents comprising a scrap sheet will also be referred to as “scrap components”. Scrap components are arranged in a scrap sheet in a unified order. The user can change the order of scrap components by performing editing operation with respect to the scrap sheet unit 7. Scrap sheet information is expressed as the array information of scrap component IDs. For example, scrap sheet information is “12345ABC,12345ABD,12345XYZ” with the IDs being delimited by delimiter character “,”. Scrap sheet information is contained and stored in event information.

In this embodiment, the operation in which the document search unit 3 performs a search, the operation in which the document display unit 5 performs display, the operation in which the componentization unit 6 componentizes a document, and the operation in which the scrap sheet unit 7 accepts a componentized document input are called “events”, and information processed in each operation is stored as “event information”.

The event generation unit 8 generates event information and inputs it to the event storage unit 9. The event information includes time information indicating when the event was executed. Each event information is of any one of types including a search type, display type, componentization type, and scrap type depending on the processing represented by the event. Search-type event information includes search query information and search strategy information. Display-type event information includes document reference information. Componentization-type event information includes document reference information and information indicating partial area. Scrap-type event information includes scrap sheet information and componentized document reference information. The event information can further have character string information called “user meta-information”.

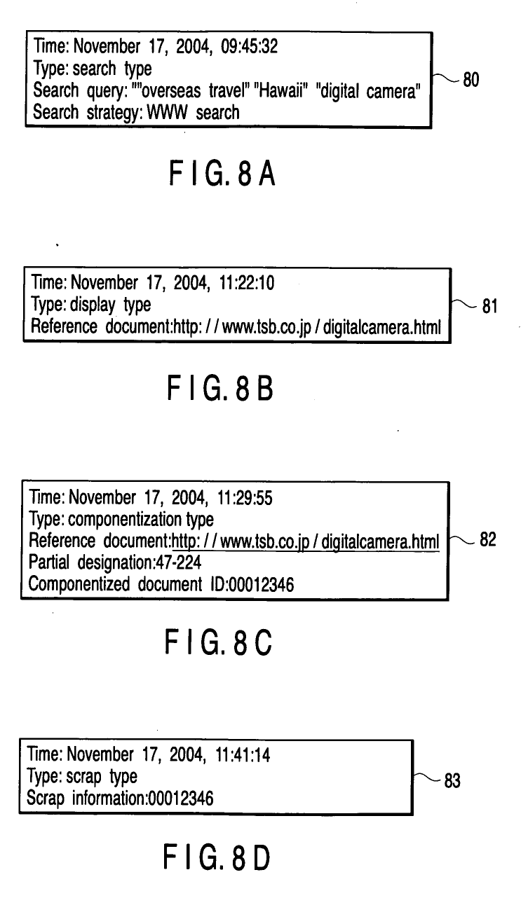

FIGS. 8A to 8D each show a specific example of event information. FIG. 8A shows a search-type event 80 in which a search was performed by using three words, i.e., “overseas travel”, “Hawaii”, and “digital camera”, as queries using a WWW search engine. FIG. 8B shows a display-type event 81 in which a document stored at a URI was displayed by the document display unit 5. FIG. 8C shows a componentization-type event 82 in which an area between the 47th character and the 224th character in a document stored at a URI was extracted, and a componentized document having ID “12345XYZ” was generated. FIG. 8D shows a scrap-type event 83 associated with scrap processing of newly adding a componentized document having ID “12345XYZ” to a scrap sheet having ID “54321ZYX”. The generated event information is input to the event storage unit 9.

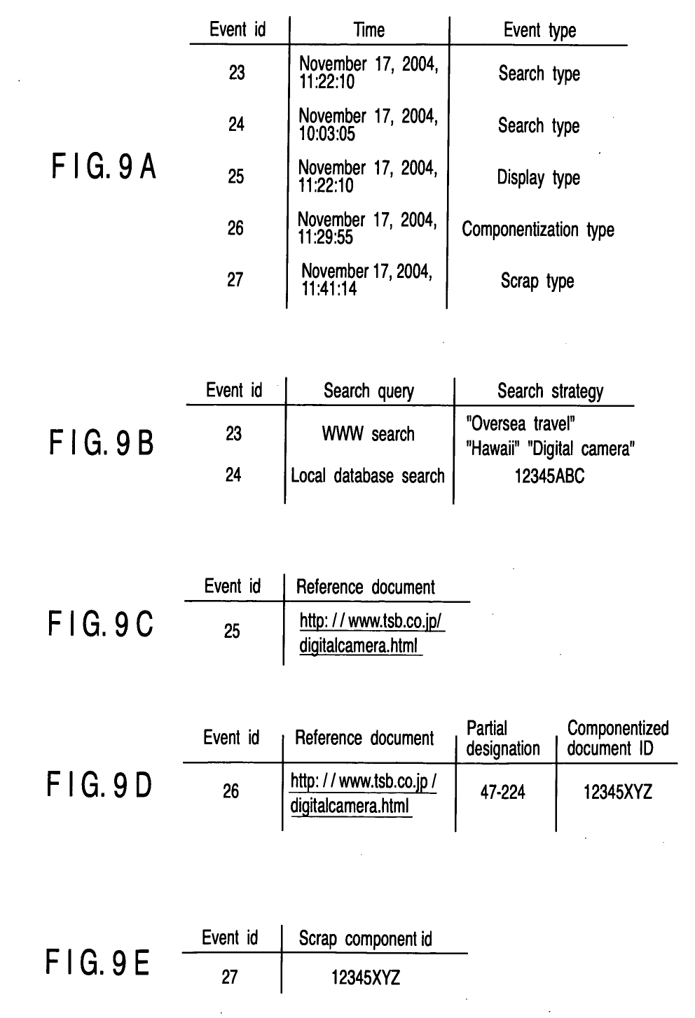

The event storage unit 9 stores all event information generated by the event generation unit 8. In this embodiment, an existing relational database management system is used to permanently store event information as information in the table form shown in FIGS. 9A to 9E. Matching with query information composed of time information, event type information, document reference information, and the like, the event storage unit 9 extracts required information from stored event information.

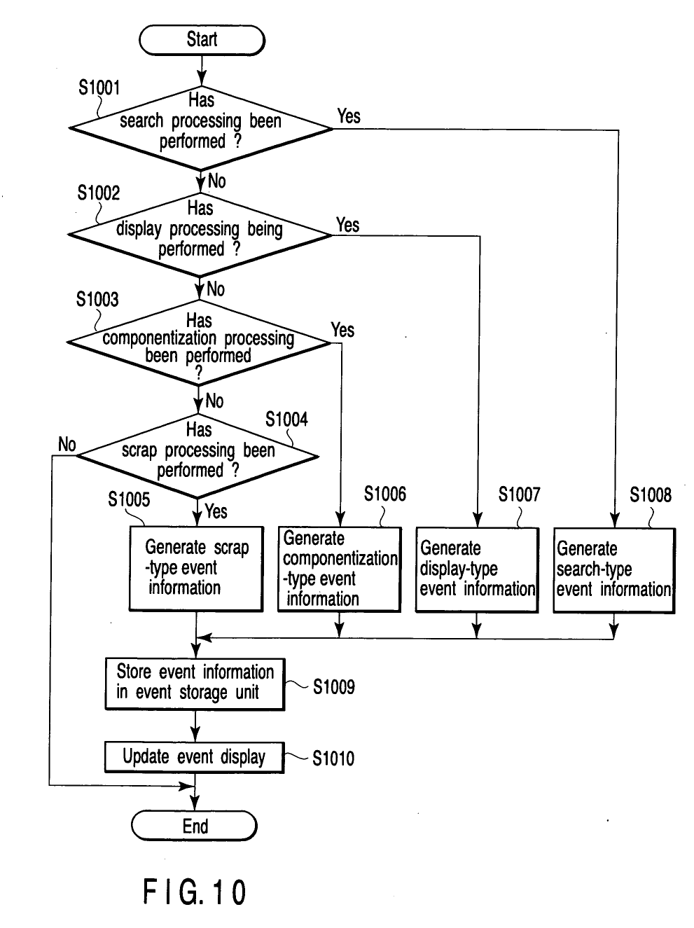

The operation in which the event generation unit 8 generates event information, and the event storage unit 9 stores it will be described with reference to the flowchart shown in FIG. 10. In steps S1001 to S1004, it is determined which type of event information should be generated. In accordance with the determined type, necessary information like that shown in FIGS. 9A to 9E is acquired to generate event information (steps S1005 to S1008). The generated event information is registered in the database of the event storage unit 9 (step S1009). When the event information generation processing is complete, the event display unit 10 (to be described later) performs display update processing and displays the resultant information on the screen (step S1010).

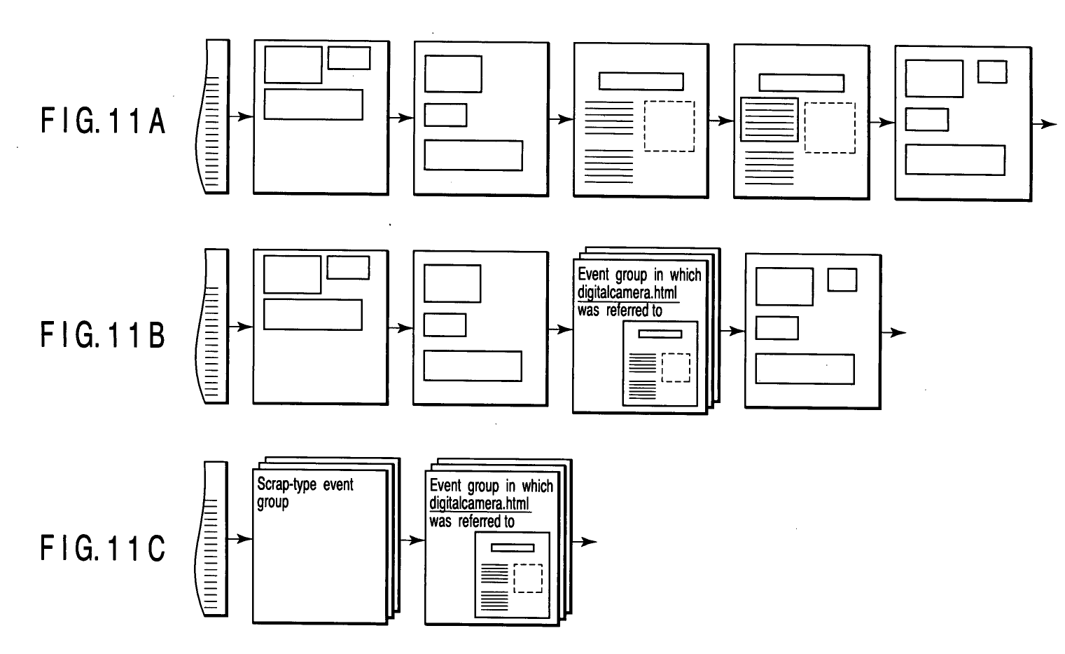

The event display control unit 11 accepts user operation and performs setting for display. With regard to the display of event information, the granularity and time interval of event information to be displayed can be variously changed. The granularity of event information indicates a phase when a plurality of associated events are to be displayed altogether, as shown in FIGS. 11A to 11C. A time interval indicates an interval corresponding to the display of part of an entire event sequence which is displayed in accordance with the window area of the event display unit 10 and the above granularity. The time interval can be changed in accordance with the scroll position and the like on the event display unit 10. The event display control unit 11 generates information called a filtering condition in accordance with user operation, and inquires of the event storage unit 9 about it.

Filtering conditions indicate designated contents associated with, for example, the following items.

Time Interval:

This information designates a time range in which events to be extracted are included. For example, the information designates the upper and lower limits of a closed interval like from “Nov. 17, 2004, 09:30:00” to “Nov. 17, 2004, 12:00:00”.

Granularity of event sequence:

This information designates a granularity when an event sequence is simply displayed. In this embodiment, as shown in FIGS. 11A to 11C, a plurality of events can be simply displayed together under conditions for three phases (to be described later). When the granularity is set to “0”, simple display is not performed, and all event information is displayed (FIG. 11A). When the granularity is set to “1” or “2”, a plurality of events are simply displayed together by the method to be described later (FIG. 11B or 1C).

Type of Event:

This information designates a specific event type to extract only corresponding event information.

Document Reference:

The reference information of a given document allows the filtering of only event information which has referred to the document.

For example, a URI like “http://www.tsb.co.jp/digitalcamera.html” allows the filtering of an event in which this document is displayed, an event in which componentization processing is performed for the document, and the like.

ID of Componentized Document:

This information designates the ID of a given componentized document to allow the filtering of only event information which has referred to the componentized document. For example, setting “12345XYZ” allows the filtering of an event in which a componentized document having this ID is generated, an event in which this componentized document is scraped, and the like.

The event display control unit 11 inquires of the event storage unit 9 as to filtering conditions, of those described above, other than those associated with the granularity of display, and obtains a corresponding event information group.

The event display control unit 11 generates event information objects in the memory on the basis of the above event information, and transfers them to the event display unit 10. These event information objects are updated every time the event display control unit 11 performs processing.

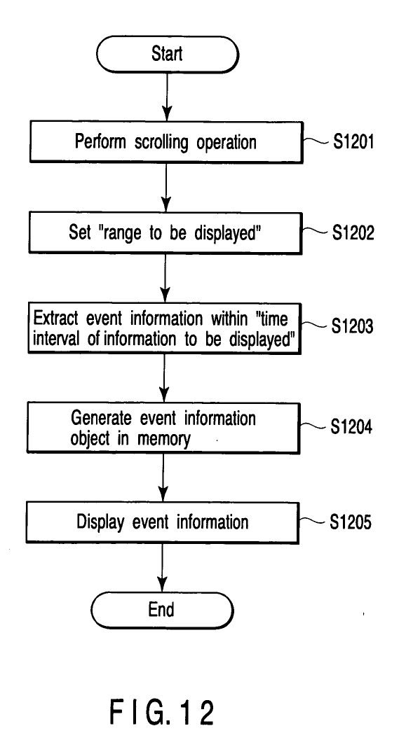

Filtering processing associated with display scroll control will be described with reference to the flowchart of FIG. 12. When the user scrolls a scroll bar on the event display unit 10 in step S1201, the “range to be displayed” of an event sequence is determined. With this operation, in step S1202, the event display control unit 11 sets “range to be displayed” information. In step S1203, the event display control unit 11 extracts event information having time information matching “range to be displayed” from the event storage unit 9 on the basis of this “range to be displayed” information, generates an event information object, and holds it in the memory (step S1204). In step S1205, event information is displayed on the basis of the event information object in the memory.

Filtering processing corresponding to the granularity of display will be described next.

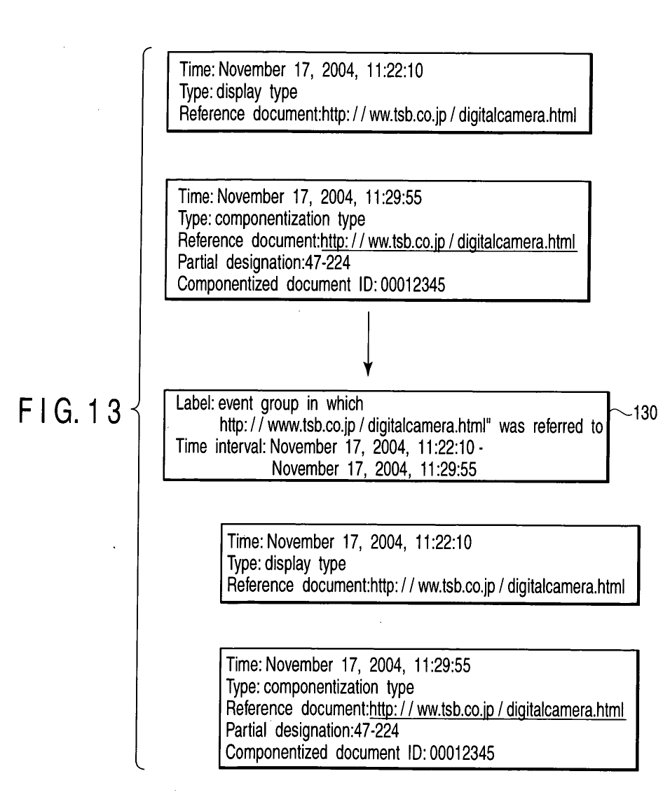

First of all, filtering conditions other than those associated with the granularity of display are processed by the above method. The event information group obtained as a result of this processing is converted into information in a form representing simplification. Simplification is expressed by attaching a label formed from a character string to a specific event sequence. When the granularity is 0, no simplification is performed. When the granularity is 1, an event sequence in which the same document is referred to is simplified. FIGS. 13 and 11B correspond to an example of processing for the granularity “1”. A sequence comprising two events in which a document stored at URI “http://www.tsb.co.jp/digitalcamera.html” is referred to is simplified. Simplification is represented by label information 130 “event group in which http://www.tsb.co.jp/digitalcamera.html was referred to”. Label information has time interval information, which indicates that the label information corresponds to the event group in the interval, i.e., the above two events.

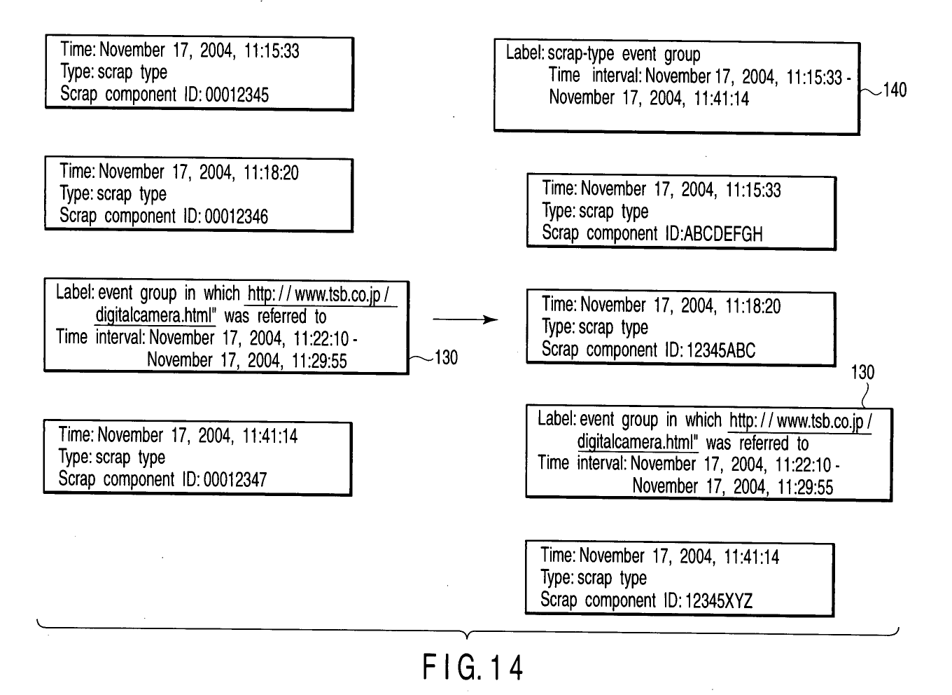

When the granularity is 2, the event sequence is simplified according to granularity “1” first, and then a scrap-type event sequence is simplified. Note that this sequence may includes a componentization-type event sequence in which scrap components are generated. FIGS. 14 and 11C correspond to an example of processing for the granularity “2”. Assume that the sequence shown in FIG. 11B has already been simplified according to the granularity “1”, and there is a sequence including three events to be subjected to scrap processing. This sequence comprises an event in which a scrap component with ID “ABCDEFGH” is scraped in a scrap sheet with ID “54321ZYX”, an event in which a scrap component with ID “12345ABC” is scraped, an event sequence 130 in which a componentized document with ID “12345XYZ” is generated from a document at URI “http://www.tsb.co.jp/digitalcamera.html”, and an event in which the generated componentized document with ID “12345XYZ” is subjected to scrap processing as a scrap component. When such an event sequence is simplified, label information 140 called “scrap-type event group” can be attached to the sequence by the same method as that used in the case of the granularity “1”.

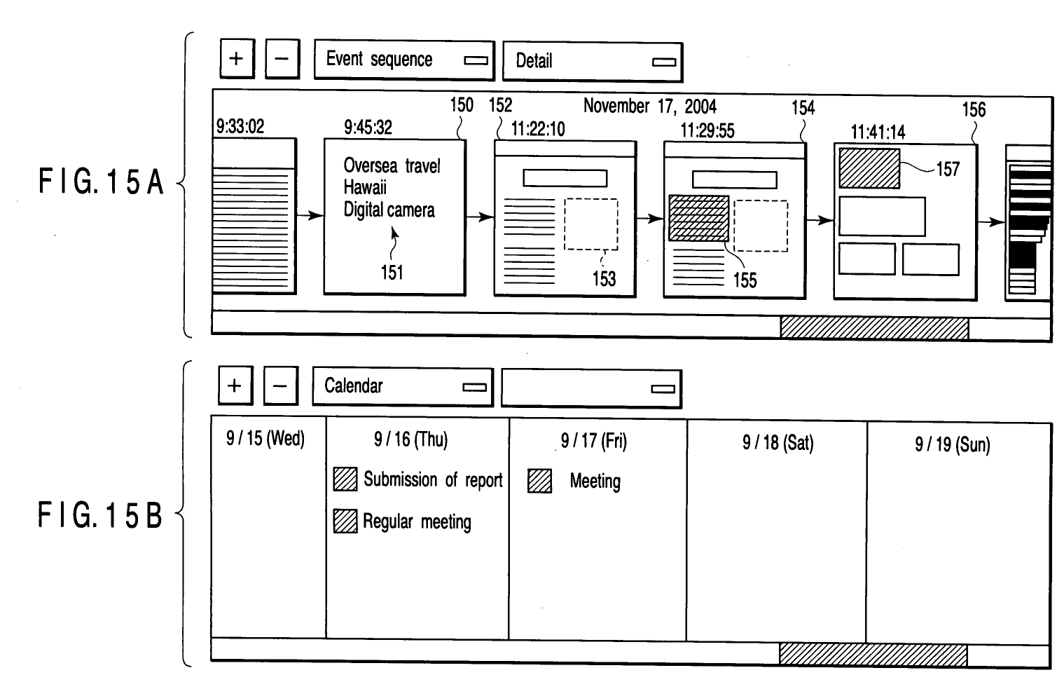

The event display unit 10 displays event information in the memory. As shown in FIG. 15A, the event information is displayed as a string of events consecutively arranged in time series order. The respective events are displayed in the following manner. A search-type event 150 is displayed together with a search query 151. A display-type event 152 is displayed together with a thumbnail 153 of a reference document. A componentization-type event 154 is displayed together with a thumbnail 155 of a reference document displayed as a componentized document. A scrap-type event 156 is displayed together with a thumbnail 157 of a scrap sheet.

When the user performs clicking operation with a mouse or the like on the display of each event information, the event display unit 10 causes various kinds of processing associated with events to take place through the event display control unit 11. When, for example, the user performs left-clicking operation, the event display control unit 11 causes the information display unit 1 to perform display processing of information associated with work which event information has.

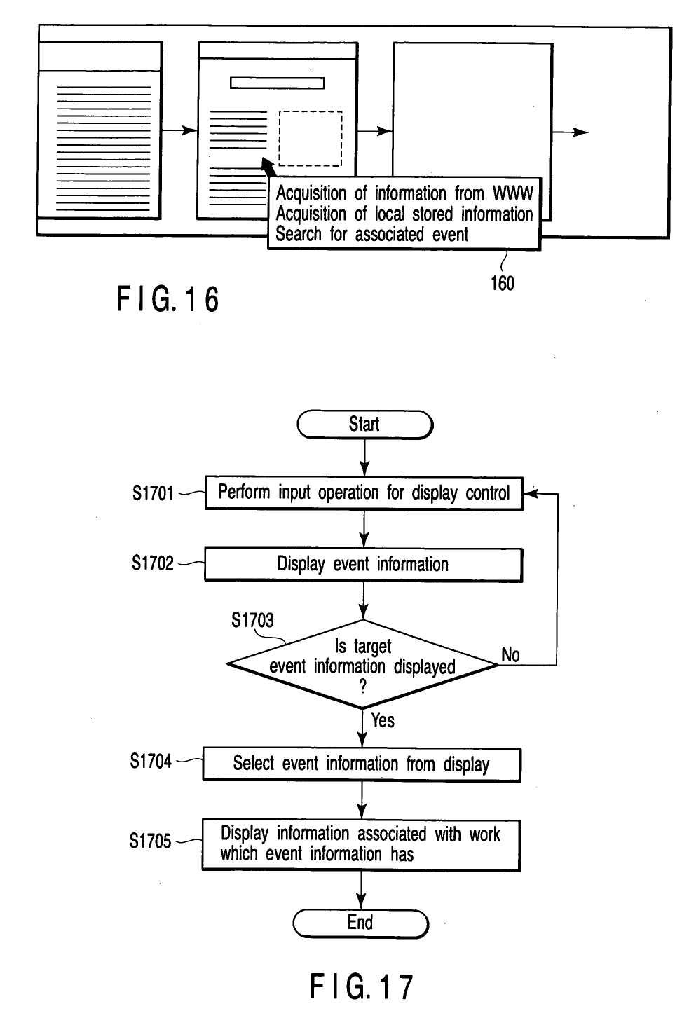

When the user performs right-clicking operation, the event display control unit 11 displays a context menu 160 like that displayed in FIG. 16. The user can select a specific menu item from the context menu 160 by performing clicking operation on the display of the item. When a menu item is selected, processing associated with the menu item is executed. For example, as shown in FIG. 16, the menu item is “acquire information from WWW”, “acquire local stored information”, “search for associated event”, or the like. In the case of a search-type event, no operation is performed on a context menu. In the case of a display-type event, a “display of events in which the same document is referred to” menu is displayed, and events in which the same document as in this event is referred to can be extracted. In the case of a componentization-type event, a “display of original document” menu is displayed, and the original document can be displayed on the document display unit 5. In the case of a scrap-type event, a “display of scrap component generation event” menu is displayed, and an event in which scrap components constituting a scrap sheet are generated can be extracted.

When the user performs input operation with respect to a scroll bar or zoom-in/zoom-out button displayed by the event display unit 10, the event display unit 10 informs the event display control unit 11 of a change in display form.

An outline of a sequence up to the display of information associated with given work in this embodiment will be described with reference to the flowchart of FIG. 17. In step S1701, the user performs input operation with respect to a scroll bar or button on the event display unit 10. In step S1702, the event display control unit 11 updates the event information in the memory to update the event display. When the user can find target work on this event display (YES in step S1703), the user performs input operation to select an event with respect to the event display unit 10. The event display unit 10 notifies the event display control unit 11 of the selected event (step S1704). In step S1705, the event display control unit 11 transfers information associated with the work which the selected event information has to the information display unit 1. The information display unit 1 displays the information associated with the work.

When the user cannot find any target work on the event display (NO in step S1703), the flow returns to step S1701. This operation can be repeated until target work is found.

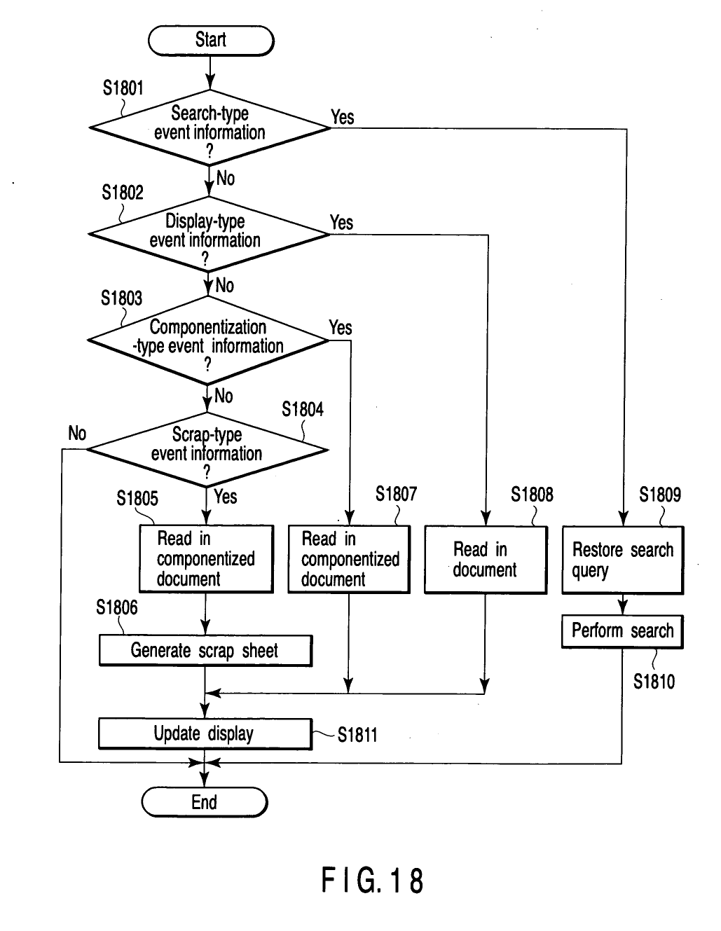

The information display unit 1 displays the information associated with the work which the event information has. A processing sequence for this operation will be described with reference to the flowchart shown in FIG. 18. In steps S1801 to S1804, first of all, the type of event information is determined by the information display unit 1. Display processing for the information is performed in accordance with the determined type.

If, for example, the search type is determined, the search query contained in the event information is input to the search query input unit 2 and restored (step S1809), and search processing is performed (step S1810). In the case of the display type, a document is acquired on the basis of the event information and supplied to the document display unit 5 (step S1808), and the display is updated (step S1811). In the case of the componentization type, a componentized document is acquired on the basis of the event information (step S1807) and supplied to the document display unit 5, and the display is updated (step S1811). In the case of the scrap type, a scrap sheet is acquired on the basis of the event information (steps S1805 and S1806), and the display is updated (step S1811) as in the above case.

According to the above embodiment of the present invention, event information comprising information associated with user work and meta-information about the work can be generated, stored, and displayed. This makes it possible to perform batch management of information associated with past work in association with work (event) log independently of a file system structure.

Since event information can be displayed together with time-series information and meta-information of work, the user can intuitively grasp the process of work performed in the past. The display form of event information can be variously changed. For example, work done over a long period of time may be displayed so as to provide an overview thereof, or displayed in a calendar form.

The user can start new work from the display of information associated with past work as a starting point. For example, the user browses a series of search operations and makes the computer display search queries generated in the past again, thereby performing a new search.

The user can easily and flexibly search for information about past work on the basis of information about work and meta-information of the work in event information. When, for example, the user is browsing a given document, he/she can easily search for information about searches which he/she has simultaneously performed, a copy source document from which a given document is copied and pasted on another document, and the like.

A specific example of use of the information management apparatus according to this embodiment will be described next with reference to the views of the accompanying drawing. In this example of use, the user is scheduled to participate in a conference of an organization called “oo technical society”. The user checks the place where the conference will be held and the contents of the conference by using the information management apparatus according to this embodiment, and organizes information about the conference. The conference is held as scheduled. On the day of the conference as well, the user generates information summarizing the conference while comfortably browsing stored event information and information summarized in a scrap sheet by using the information management apparatus according to this embodiment.

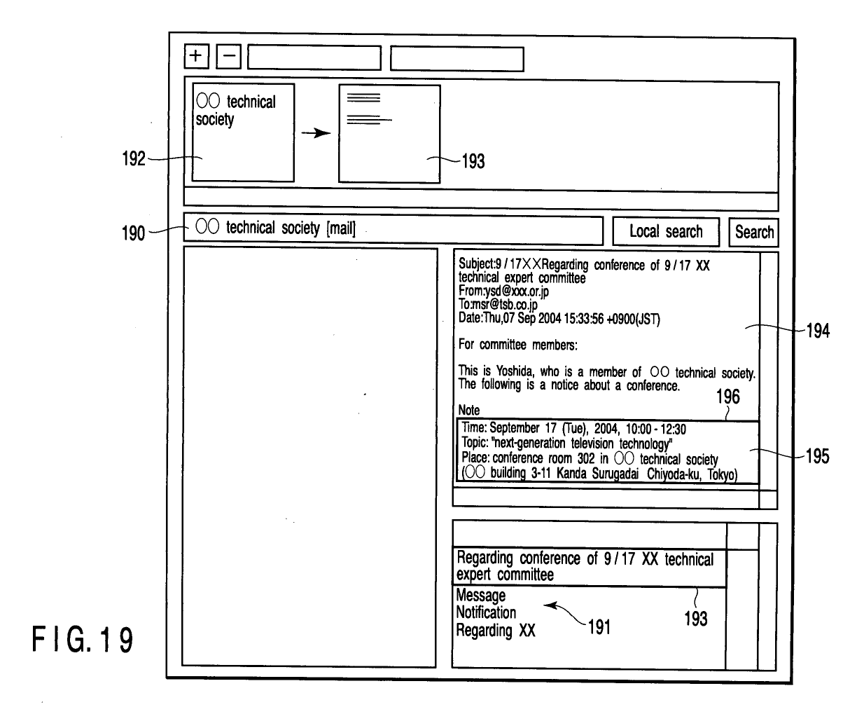

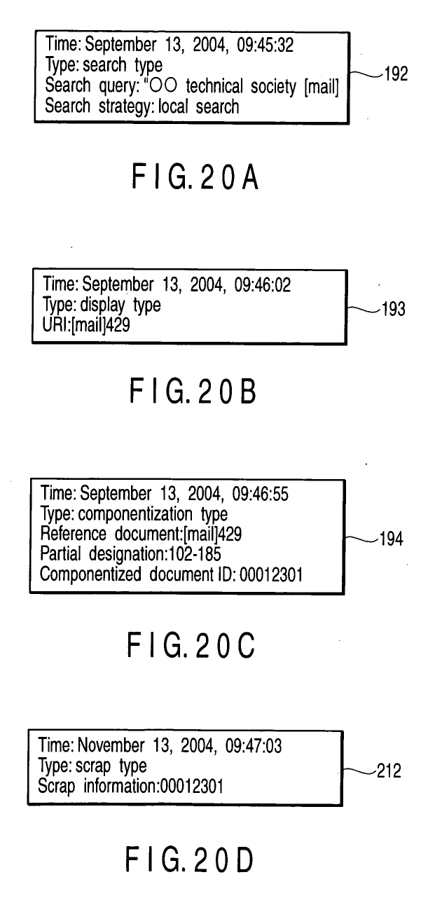

As shown in FIG. 19, first of all, the user performs a local document search by using two keywords 190, i.e., “oo technical society” and “[mail]”, to browse mail associated with the conference. The document search unit 3 retrieves a mail-type document containing the character string “oo technical society”. A result 191 is then displayed in the form of a list. At the same time, the event generation unit 8 generates search-type event information 192 like that shown in FIG. 20A, and transfers it to the event storage unit 9. The search-type event information 192 is displayed by the event display unit 10, as shown in FIG. 19.

The user selects a document 193 having the subject information “regarding conference of 9/17 interactive content technical expert committee” from the displayed list, and performs double-clicking operation on the display. Document information 194 is then read in the document display unit 5 and displayed. At the same time, display-type event information 193 like that shown in FIG. 20B is generated and displayed as shown in FIG. 19.

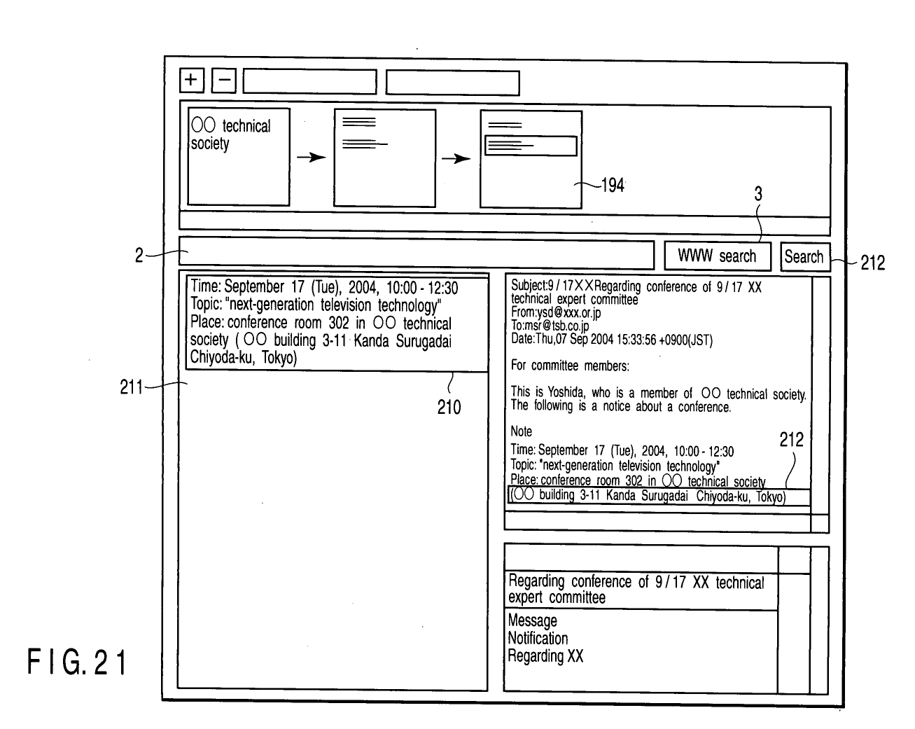

The user then selects a desired area 195 on the display to scrap desired part of the document information 194. In accordance with this selecting operation, the componentization unit 6 componentizes the document area in the document, and actually draws a rectangle 196 like that shown in FIG. 19. In addition, componentization-type event information 194 like that shown in FIG. 20C is generated and displayed as shown in FIG. 21.

A generated componentized document 210 is scraped and incorporated in a scrap sheet 211 by being dragged and dropped from the display of the generated componentized document onto the display of the scrap sheet. At the same time, scrap-type event information 212 like that shown in FIG. 20D is generated and displayed.

The user performs a WWW search on the basis of information indicating an address in the document. The character string “oo building 3-11Kanda Surugadai Chiyoda-ku, Tokyo” in a rectangle area 212 shown in FIG. 21 is input to the search query input unit 2. The user also switches the search strategy display on the document search unit 3 to “WWW search” and presses a search button 212. The query character string is then transmitted as a search query to the WWW search engine. As a consequence, a document indicating the search result is obtained and displayed on the document display unit 5. With this operation, a search-type event is generated. Assume that in this embodiment, no event information is generated concerning the display of the document indicating the search result obtained by the WWW search engine.

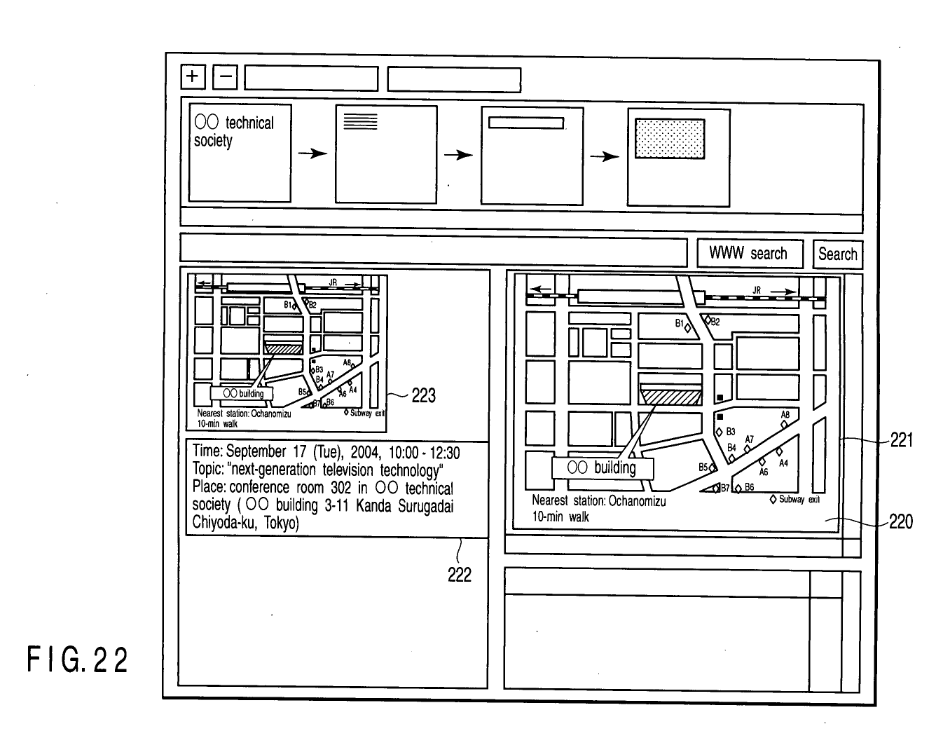

The user selects anchor information in the document, and performs clicking operation on the display of the information. As a result, the document display unit 5 reads in a document 220 like that shown in FIG. 22 which is indicated by the URI which the anchor information has. In addition, a display-type event is generated.

The user browses the obtained information about an area surrounding the conference place, and componentizes an area 221 including a map in the document and nearest station information. Scraping operation is performed for a componentized document 223 generated by this operation. The resultant information is inserted in a portion above a componentized document 222 of mail which has been previously scraped. With the above work, a componentization-type event and scrap-type event are generated.

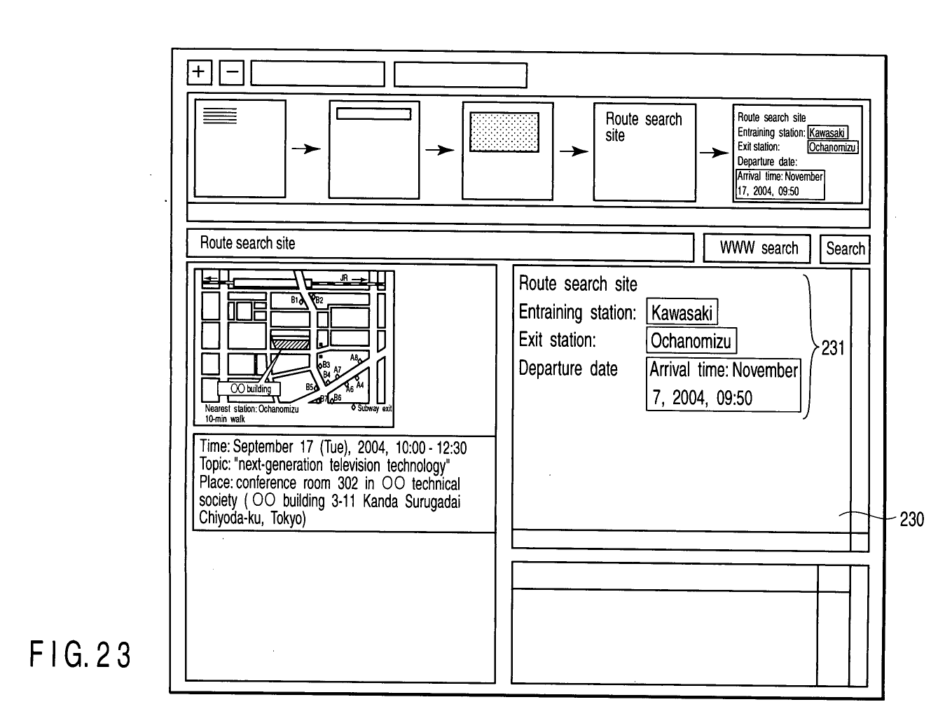

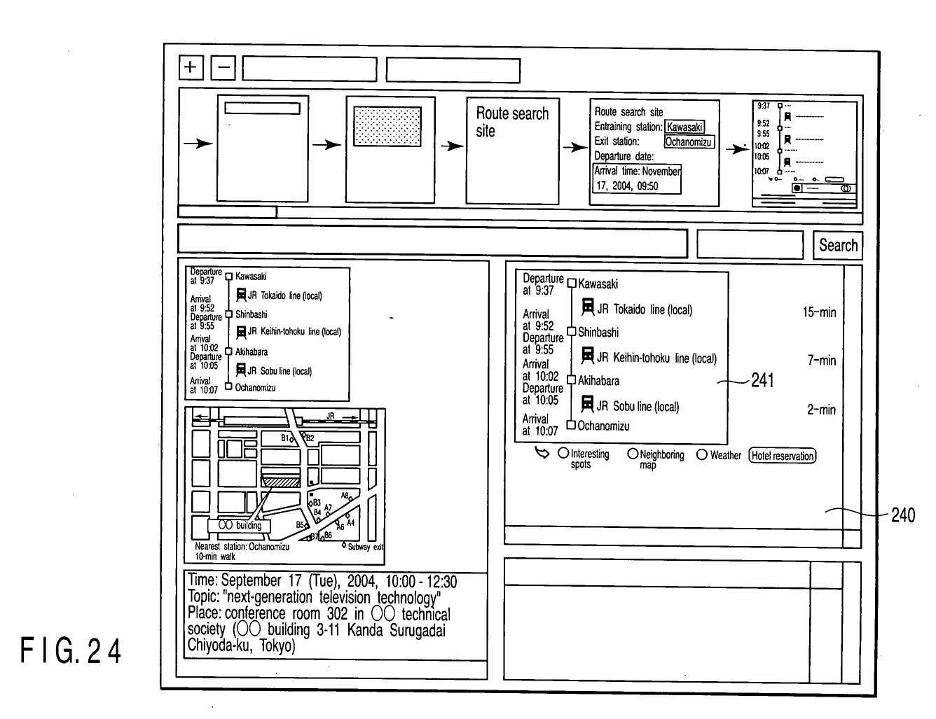

The user then uses a service called “route search site” which is provided on WWW as shown in FIG. 23 to check a train route to the conference place and a schedule to be taken on the day of the conference. For this purpose, the user performs a search on WWW by using the character string “route search site” as a query. As a search result, anchor information for a document for the input of a route search query to the route search site is obtained. This anchor is clicked to display a document 230. Performing input operation with respect to the document 230 can set the departure place and destination of a route to be retrieved in the route search site. The user inputs a departure place, destination, date, arrival time, and the like to an area 231 called a form in the document 230 while browsing the scrap sheet. When the user performs pressing input on search button display on the form, a route is retrieved by the route search site, and a document 240 indicating route information as shown in FIG. 24 is input to the document display unit 5. The user componentizes an area 241 including the route information in the document 240, and scraps it. With the above work, a search-type event and two display-type events are generated.

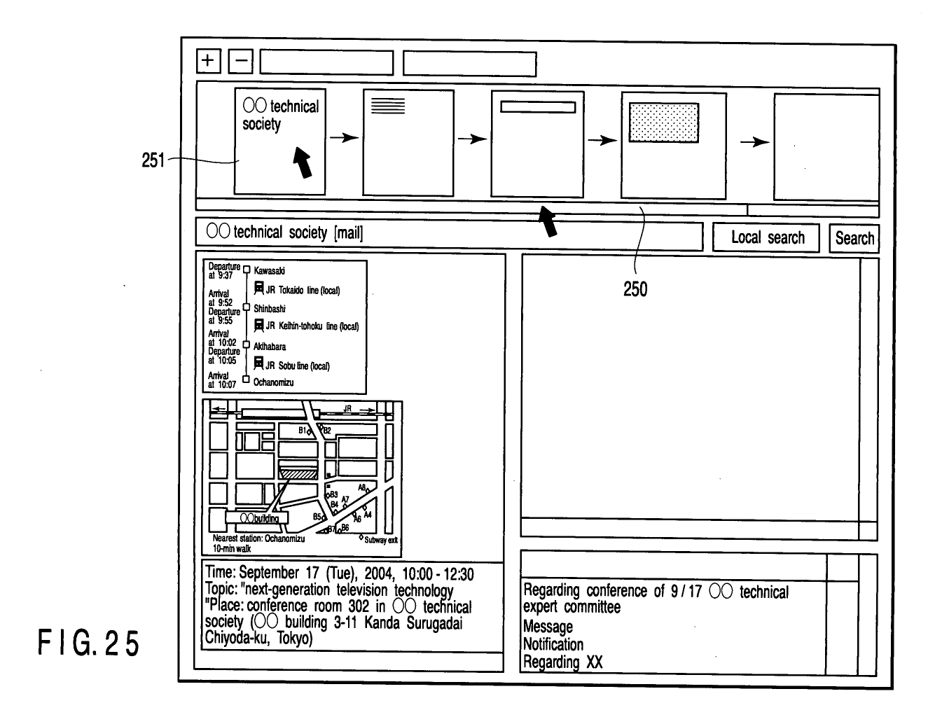

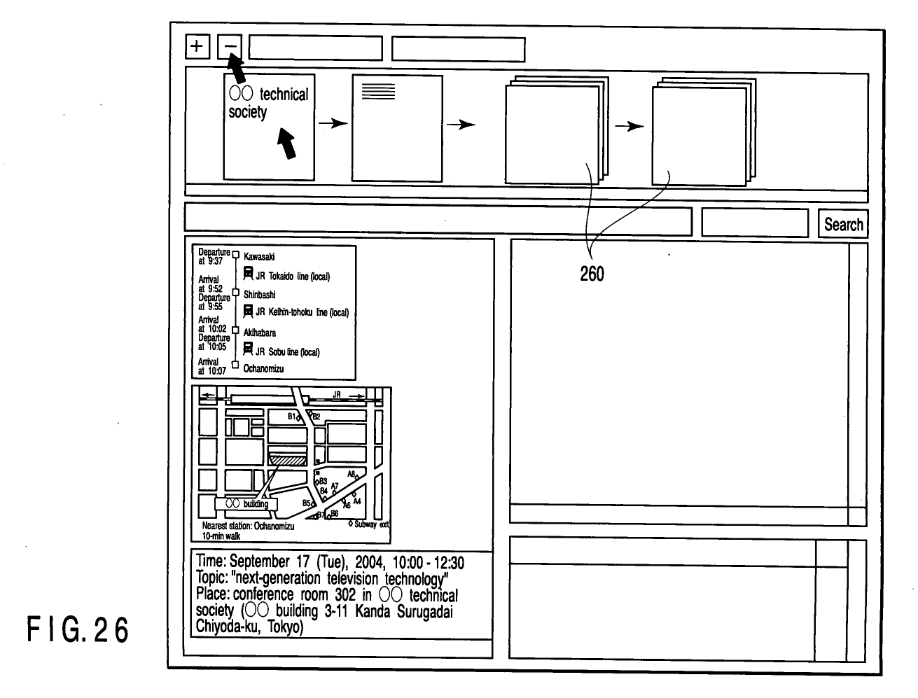

The operation of repeating a previous search by using event information will be described. When the user scrolls a scroll bar 250 on the event display unit 10 shown in FIG. 25, the range information of a display event sequence which the event display control unit 11 has is changed. With scrolling operation, the current position is moved to the left to find initial event display 251 in this embodiment. In this case, a past event sequence can be flexibly browsed by using the simplified display provided by the event display unit 10. When the user performs many scraping operations, or componentizes/scraps many portions of a document, or edits a scrap book many times, an event sequence becomes very long. In such a case, the long event sequence can be converted into a short sequence 260 like that shown in FIG. 26 by simplification, and the user can browse it. When the user performs clicking operation on the display of a found event, the event display control unit 11 sets, in the document search unit 3, the search query and search strategy which the event information holds. With this operation, the document search unit 3 executes a search, and the search result is displayed in the form of a list. With this work, a search-type event is generated.

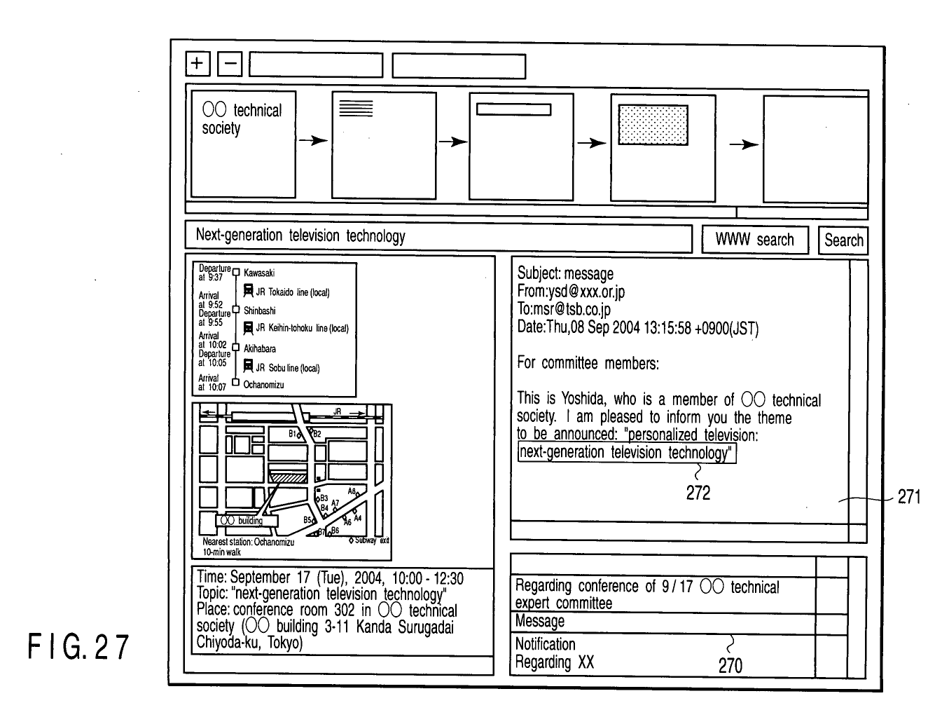

Referring to FIG. 27, when the user selects mail information 270 having the subject information “message” which is displayed second from the search result list, a corresponding document 271 is displayed, and a display-type event is generated.

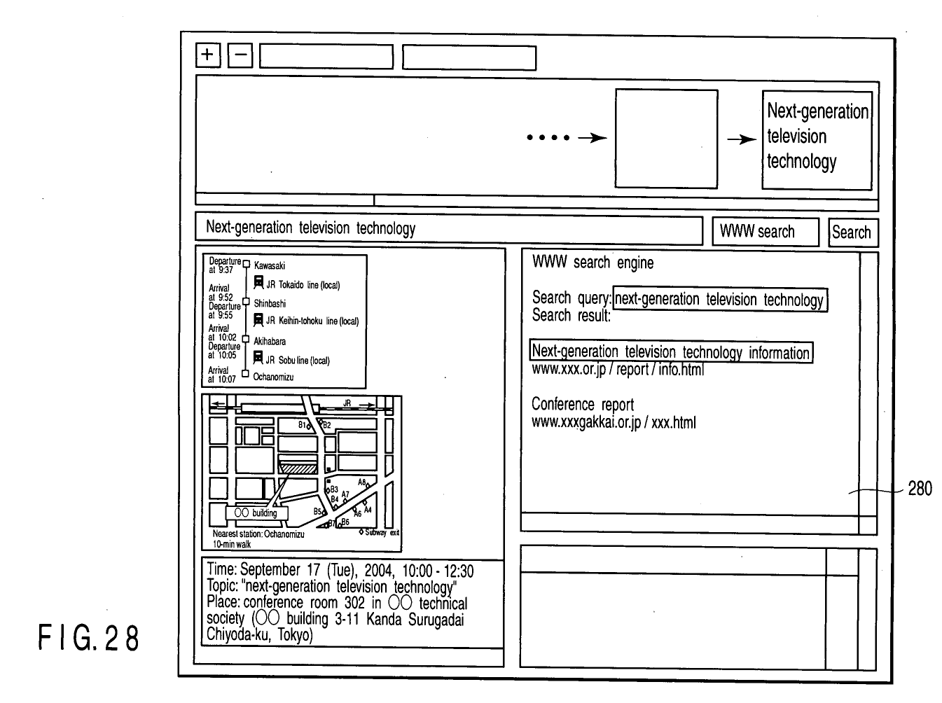

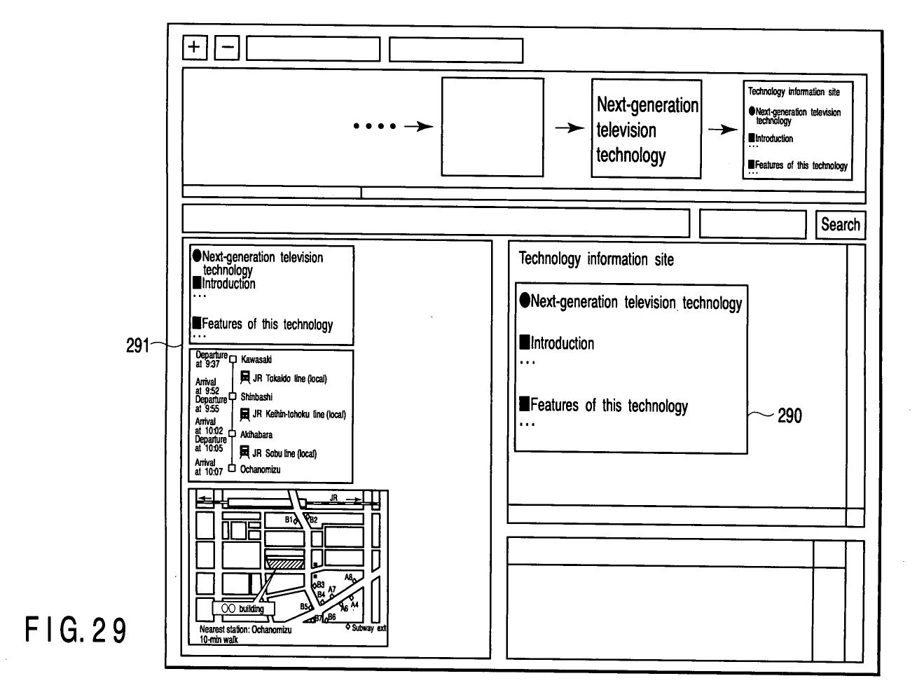

When the user performs a WWW search by using a character string 272 “next-generation television technology” in the document 271 shown in FIG. 27 as a search query, the character string “next-generation television technology” is extracted from the document, and a search is performed. A document as a material associated with the conference can be displayed by using anchor information in a search result document 280 shown in FIG. 28. FIG. 29 shows the document display result. Referring to FIG. 29, a part 290 of the document can be componentized and scraped. With the above work, a search-type event, display-type event, componentization-type event, and scrap-type event are generated in the order named.

A scrap sheet 291 generated by the above series of operations can be set as TODO-type event information. A method of generating TODO-type event information will be described below.

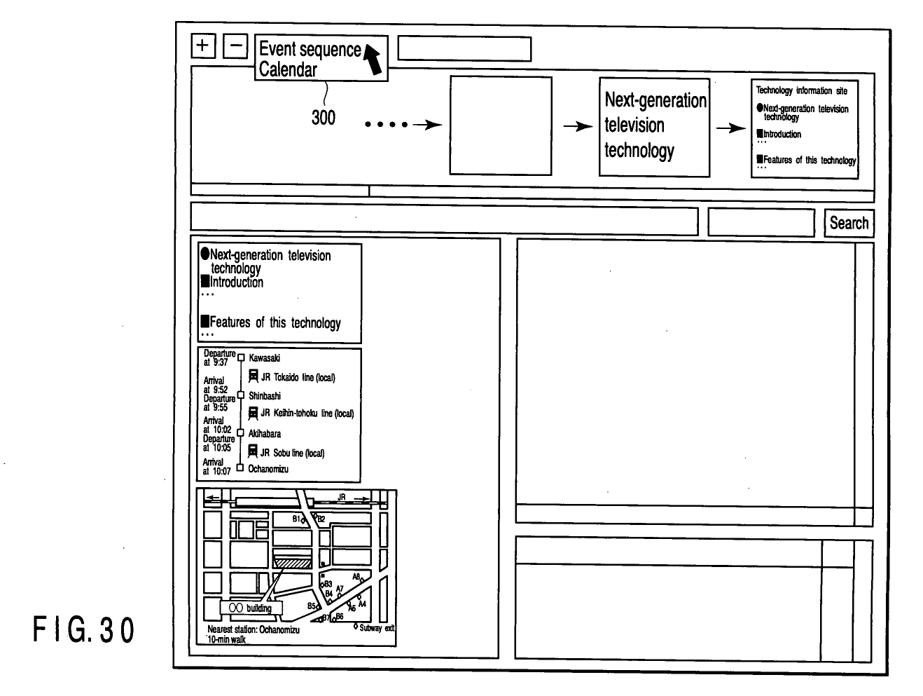

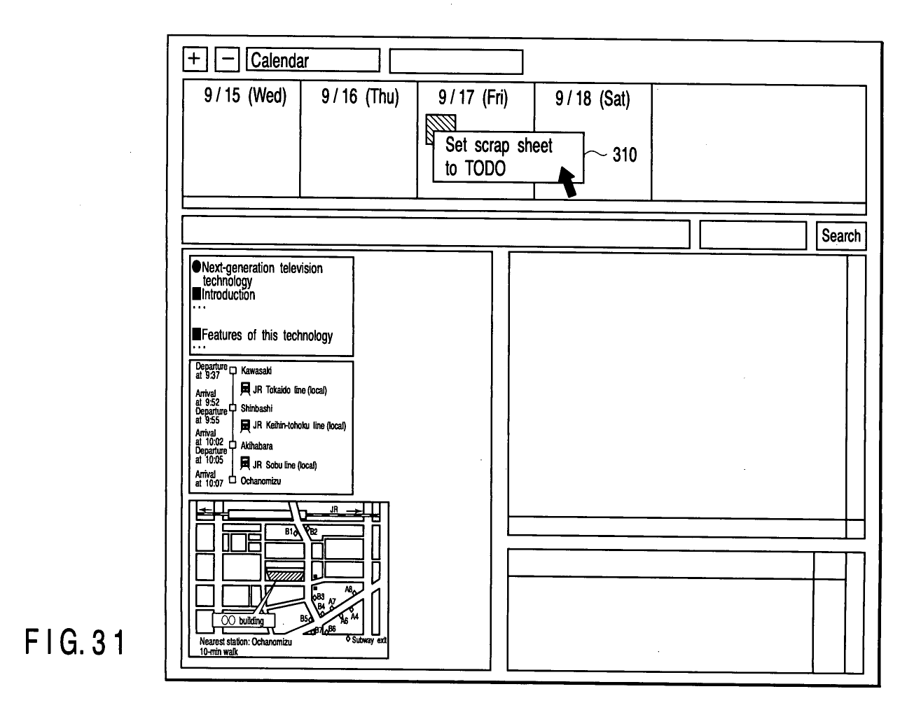

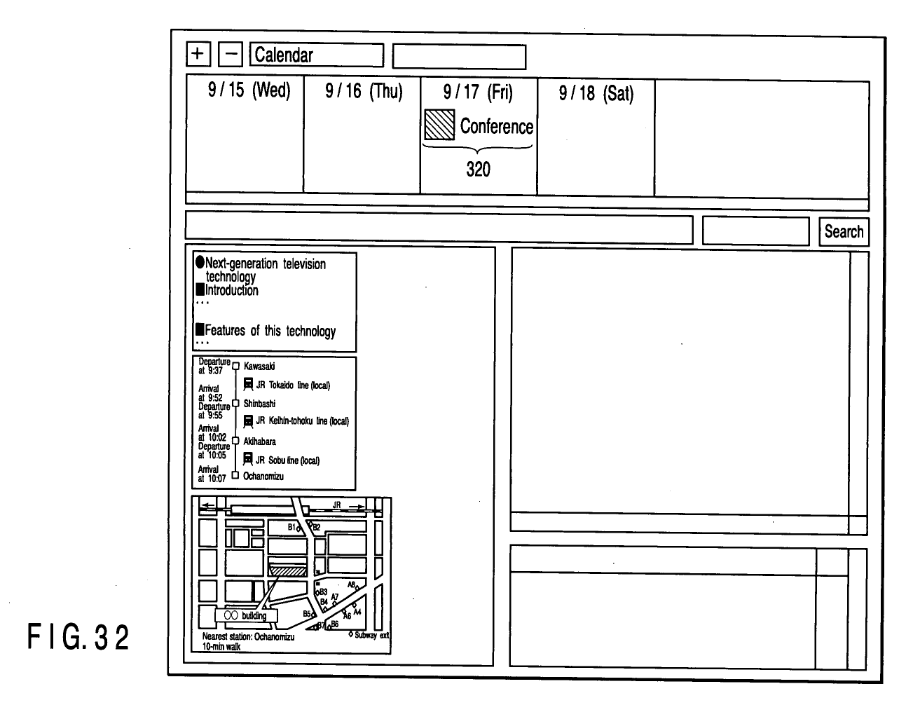

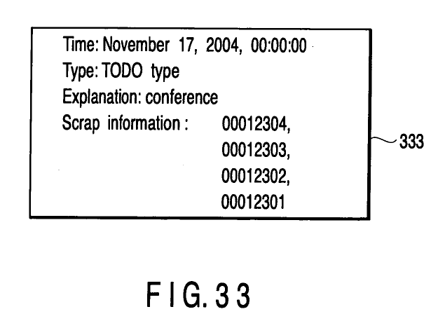

As shown in FIG. 30, first of all, the user operates a display mode combo box 300 in the event display unit 10, and switches the event display to a calendar form. As shown in FIG. 31, the user performs scrolling operation to display a sequence corresponding to “September 17” on which the conference will be held. When the user performs right-clicking operation on the display of “September 17”, a context menu 310 is displayed. The user performs clicking operation on the menu “set scrap sheet to TODO” in the context menu 310. TODO event information 333 like that shown in FIG. 33 is generated by the event generation unit 8. The TODO event information 333 is supplied to the event storage unit 9 and displayed as a TODO event 320 by the event display unit 10 as shown in FIG. 32. A character string can be set as an explanation in the TODO event information 333. When the user performs clicking operation on the TODO event 320, display for prompting the user to input a character string is performed to allow the user to input a character string. When the user performs clicking operation outside the display after input operation, the input is confirmed. The display of the input character string can be added to the TODO event display. As described above, the same processing as that performed by the calendar function which a PIM (Personal Information Manager) has can be performed.

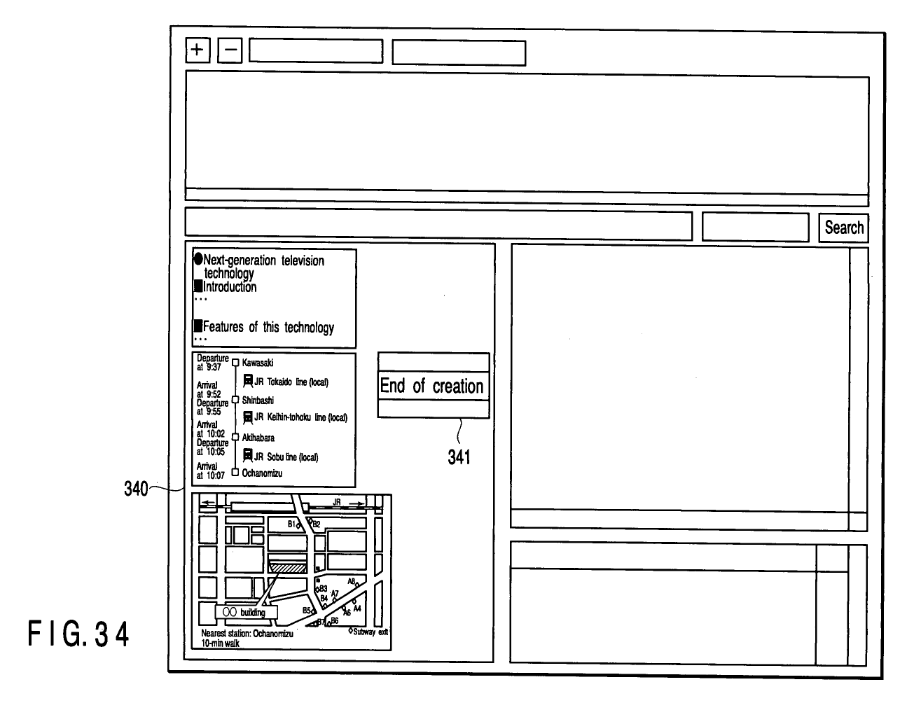

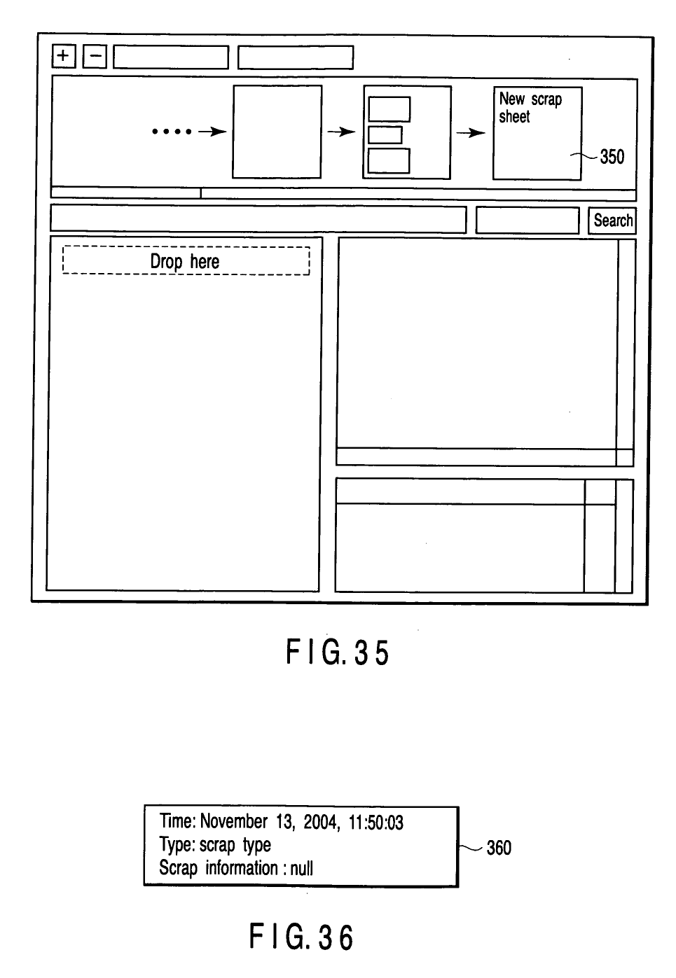

As shown in FIG. 34, when the user performs right-clicking operation on scrap sheet display 340, a context menu 341 is displayed. When the user performs clicking operation on the menu “end of generation” in the context menu 341, the scrap sheet unit 7 recognizes that scrap sheet generation processing is complete, and stores scrap sheet information in the local database. The scrap sheet unit 7 deletes componentized document information in the scrap sheet information, and updates the scrap sheet to a scrap sheet having ID “0000001”. With this operation, a scrap sheet is newly generated. Scrap-type event information 360 like that shown in FIG. 36 is generated, and a event 350 of the new scrap sheet is displayed as shown in FIG. 35.

On the day of the conference, the user generates information summarizing the conference while browsing the information organized in the scrap sheet and a past event sequence. A description of the generation of events will be omitted below.

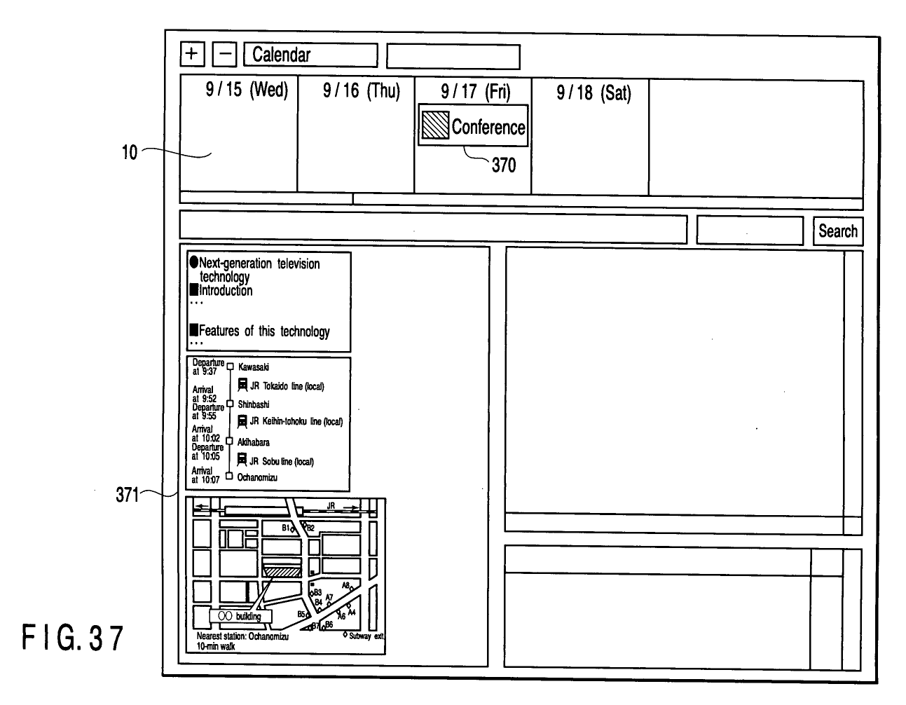

As shown in FIG. 37, the user switches the display on the event display unit 10 to the calendar display so as to make it display the day of the conference. This display includes display 370 of the already set TODO event. When the user performs clicking operation with respect to the TODO event display (conference) 370, a scrap sheet 371 is read in the scrap sheet unit 7 and displayed.

Two other methods of searching for a past scrap sheet will be described. When no TODO event is set, these methods can be used.

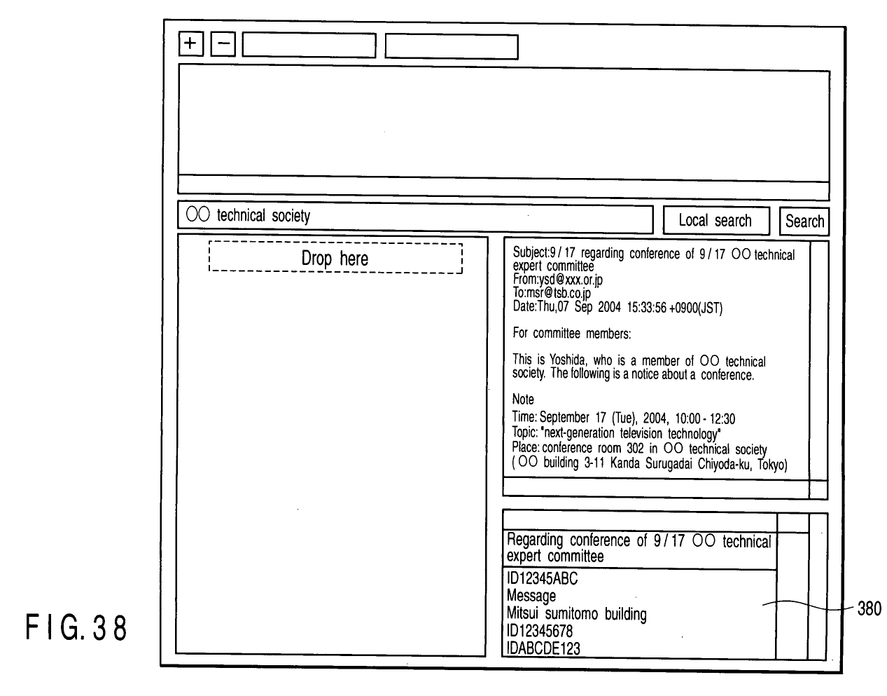

A search is made by using the keyword “oo technical society” (first method). As a consequence, as shown in FIG. 38, a list 380 of a document associated with the conference, an already generated scrap sheet, and componentized documents and the like is displayed. If a scrap sheet can be found from this list display, the scrap sheet can be read in by performing double-clicking operation with respect to the display indicating the scrap sheet.

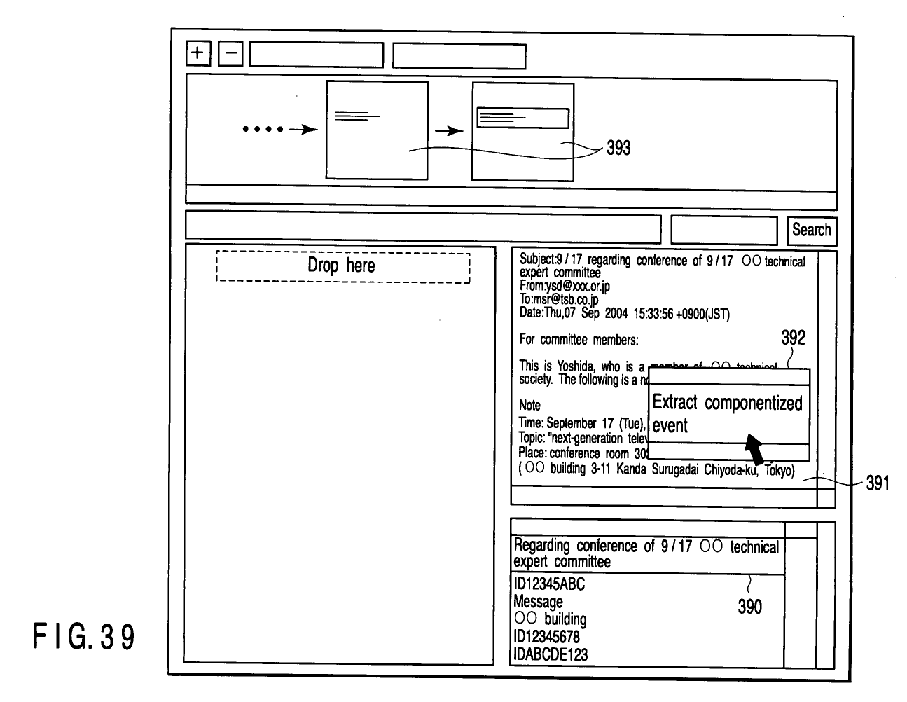

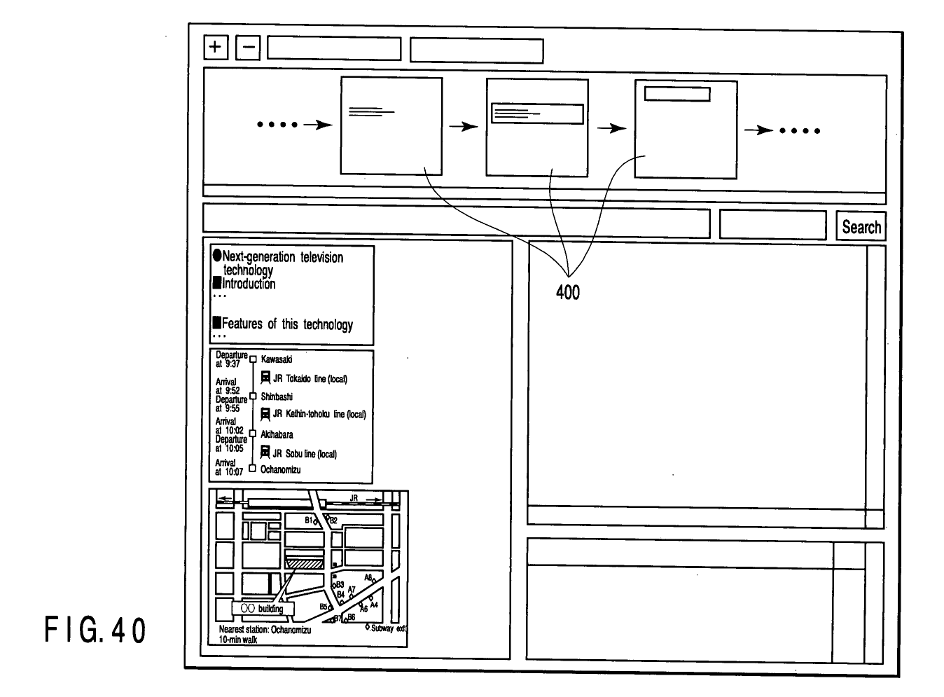

If no scrap sheet can be found from the list display, a target scrap sheet can be easily tracked back from a document scraped in the scrap sheet (second method). As shown in FIG. 39, the user performs double-clicking operation with respect to a document 390 found in the displayed list to make the document display unit 5 display it. The user performs right-clicking operation on a document 391 displayed by this operation, and makes the document display unit 5 display a context menu 392. The user selects an “extract componentized event” menu on the context menu 392. An event filtering unit then extracts a componentization-type event in which this document is referred to from the event storage unit 9. As shown in FIG. 39, an extracted event group 393 is displayed. When the user finds out a componentization-type event at the time of the generation of the scrap sheet from the event group 393, and performs clicking operation on the event display, the event display control unit 11 displays the same information as that displayed when componentization was performed. When the display of the event display unit 10 is switched to detailed display, a detailed event sequence 400 located before and after componentized events is displayed as shown in FIG. 40. It is easy to find out, for example, a scrap event after this document is componentized. This makes it possible to read in the target scrap sheet.

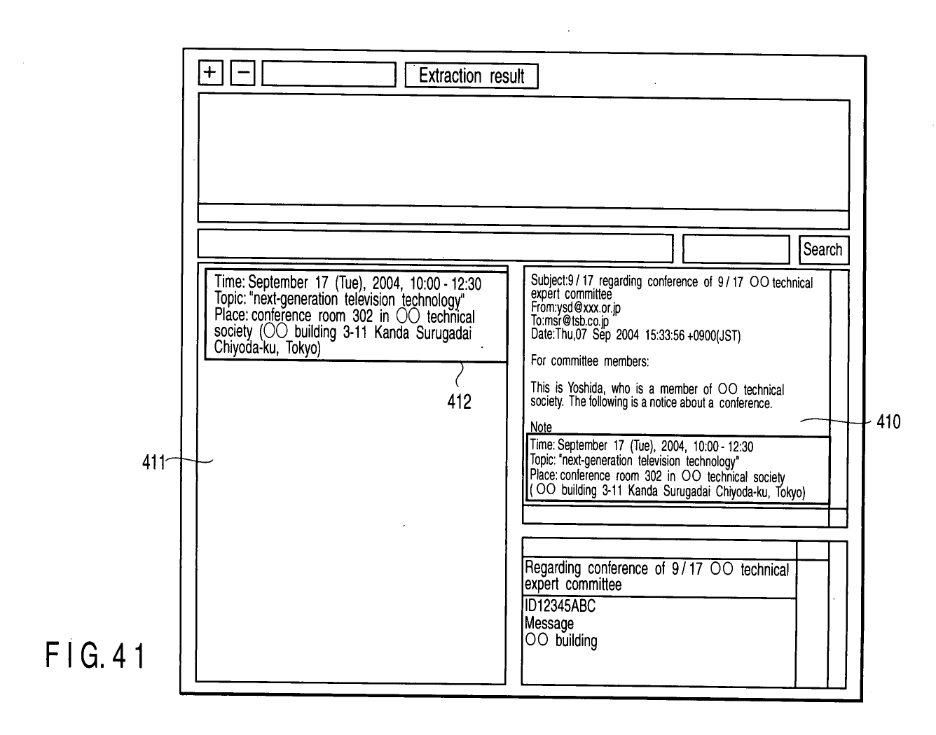

When componentization is performed and scrap processing is performed from, for example, a state wherein a mail document 410 is displayed as shown in FIG. 41, the current scrap sheet is immediately switched to a newest scrap sheet 411, and a scrap 412 is inserted in the newest scrap sheet 411. That is, any new componentized document cannot be scraped or edited with respect to a scrap sheet generated in the past.

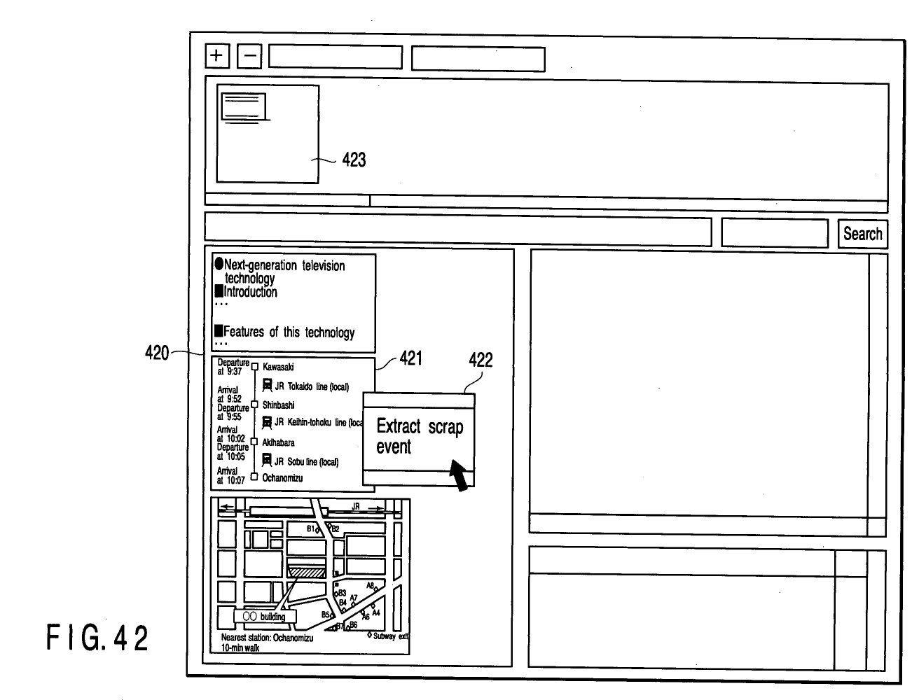

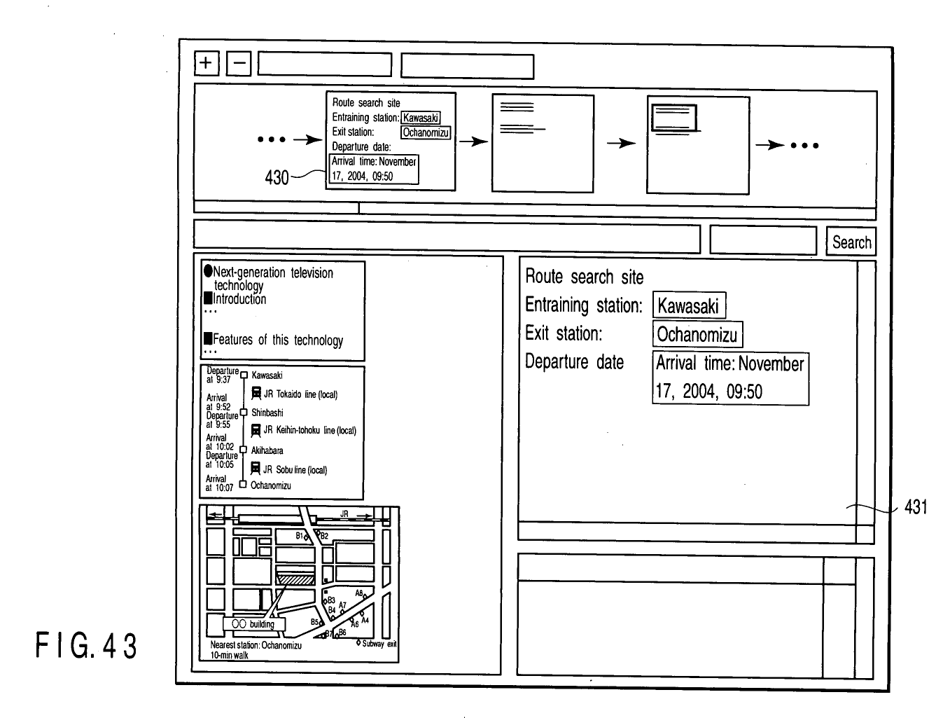

A case wherein the user will change the departure time and search for a movement schedule by using a route search service on WWW will be described below. As shown in FIG. 42, when the user performs right-clicking operation on a componentized document 421 indicating a route on a scrap sheet 420, a context menu 422 is displayed. In the context menu 422, the user selects “extract scrap event”. Event information 423 upon scraping is extracted from the search result obtained by a route search service, and is displayed. The event display 423 is selected to re-display a document for the route search service which the event information 423 has. When, for example, the current display of the event display unit 10 is switched to detailed display as shown in FIG. 43, a search query input document 431 for the route search service can be found from a display-type event 430 two events preceding the re-displayed event. The user can use the route search service again by such easy work.

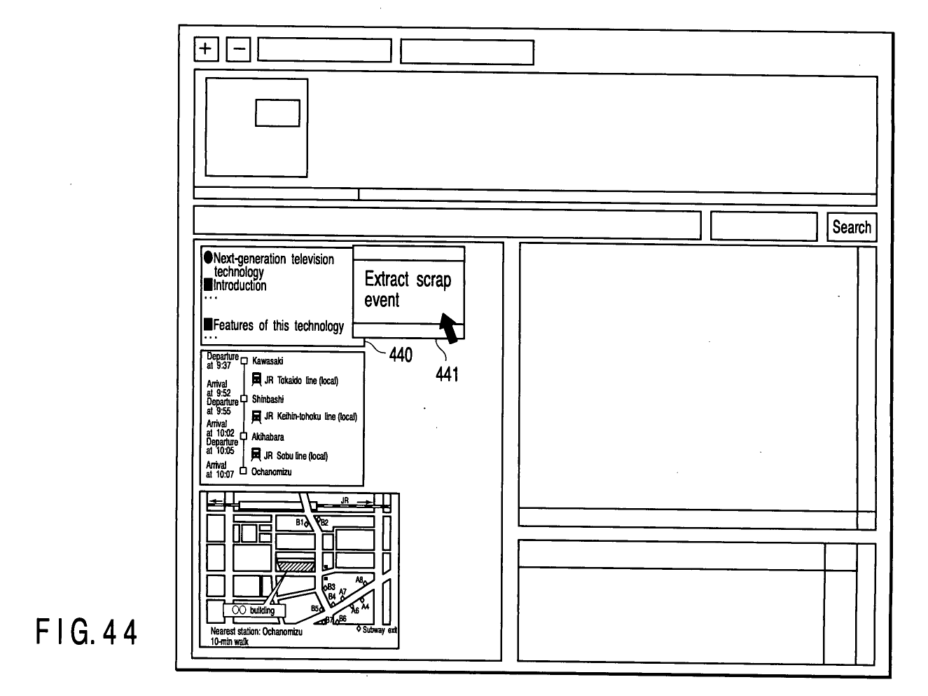

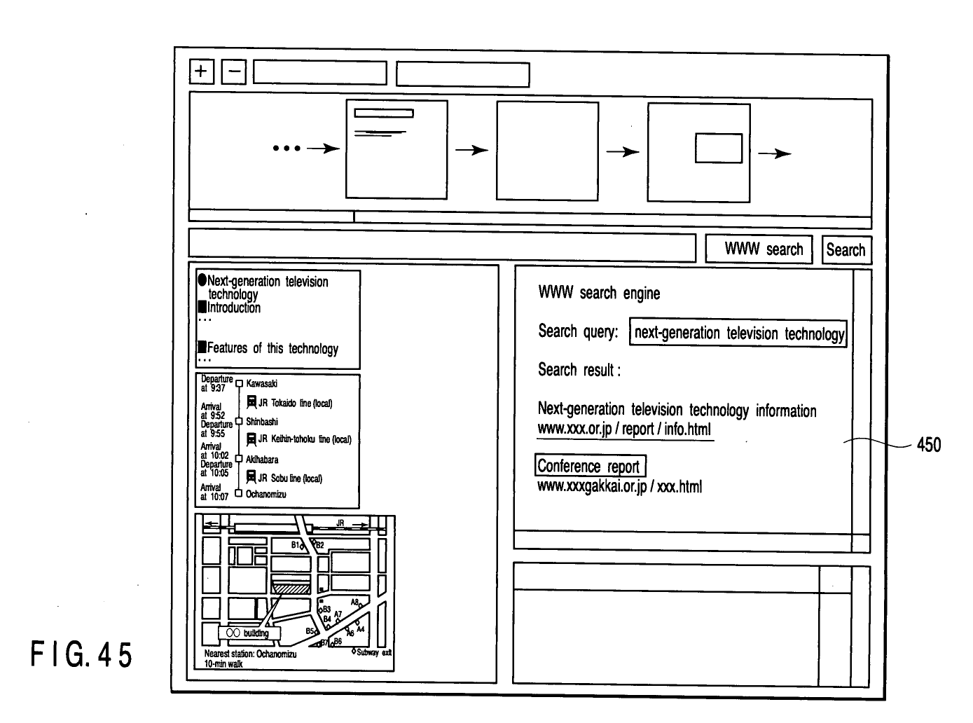

During the conference, the user further checks matters relevant to the conference. In this case, as shown in FIG. 44, from a componentized document 440 indicating a related document in the scrap sheet, an event at the time of scraping from the related document can be tracked back by using a context menu 441 “extract scrap event”. As shown in FIG. 45, by switching the event display to detailed display, a search result document 450 obtained by a WWW search can be found. The document 450 can be displayed again, and other search results can be displayed. In addition, a search can be performed again by changing the search query.

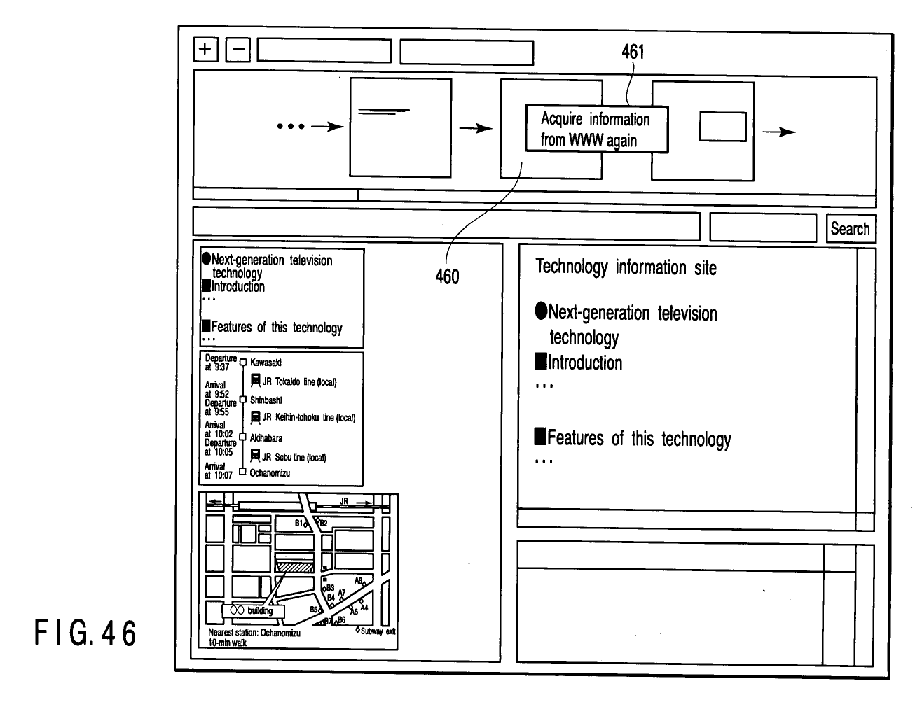

Once a document on WWW is displayed, document information is stored in the local database. When the user left-clicks information associated with work of a document-display event to display the information, document information in the local database is read in. In this case, as shown in FIG. 46, when the user performs right-clicking operation on document display event display 460 to display a context menu 461, and selects the “acquire from WWW” menu, a document on WWW is acquired and displayed again. With this simple operation, latest document information can be obtained.

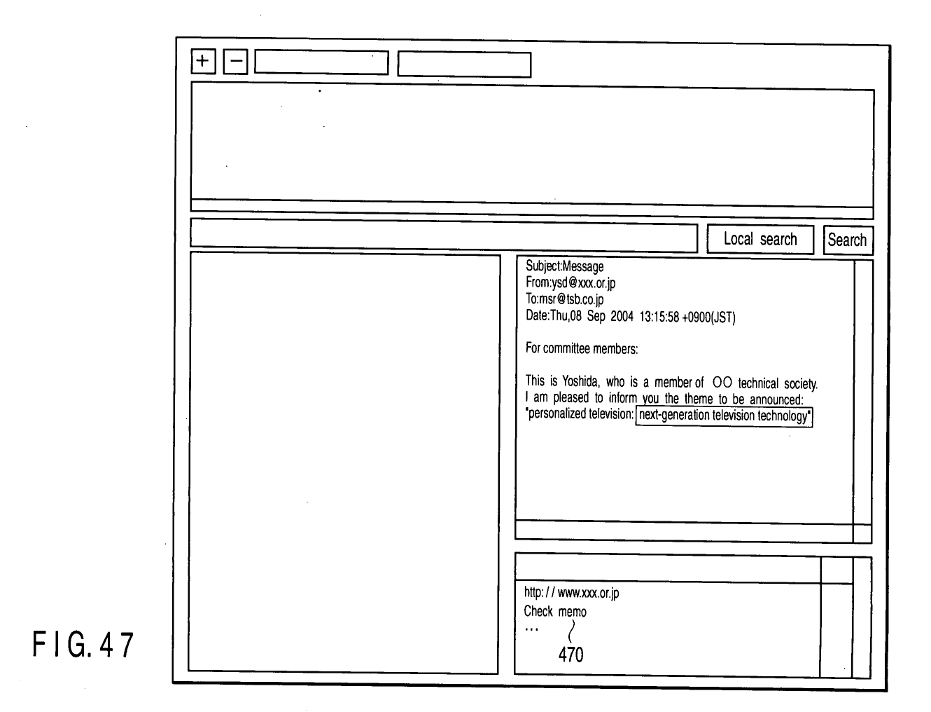

Assume that the user has generated a memo document while browsing related documents during preparation for the conference. In this case, if a memo document 470 is displayed once in advance, the document can be found together afterward when the related document is retrieved, as shown in FIG. 47.

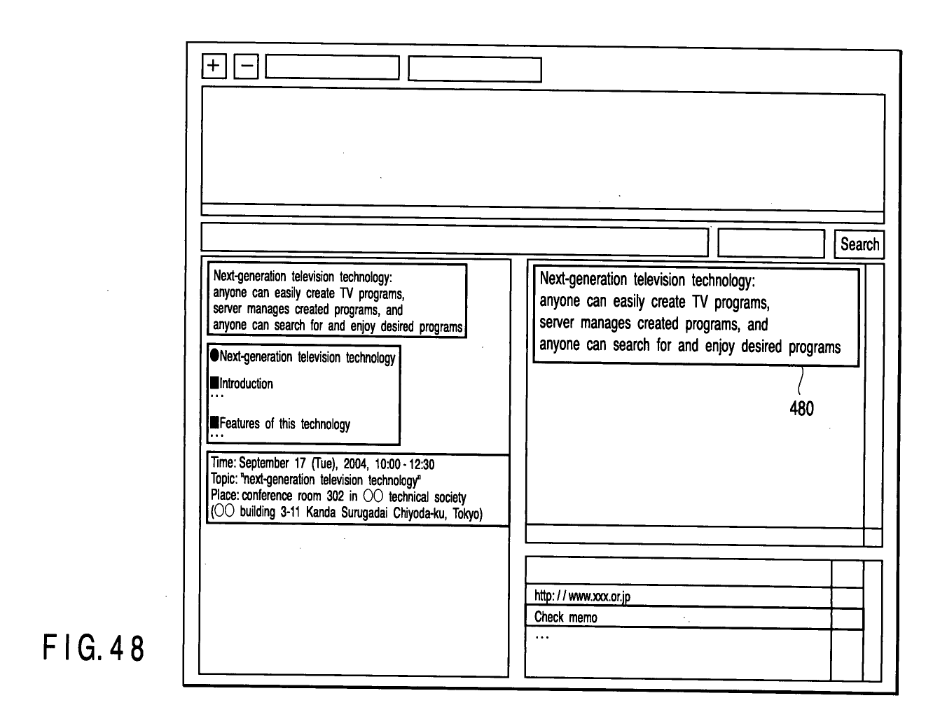

A case wherein the user generates a new scrap sheet on the day of the conference will be described. As shown in FIG. 48, the user can generate a document for summarizing the conference by newly scraping a part 480 of a document to be browsed, using a past scrap sheet. When the user performs scraping operation in the process of using a past scrap sheet, the scrap sheet is switched to the latest scrap sheet. Since a display event of a past scrap sheet exists near the event sequence, scrap sheets can be easily switched to another scrap sheet again.

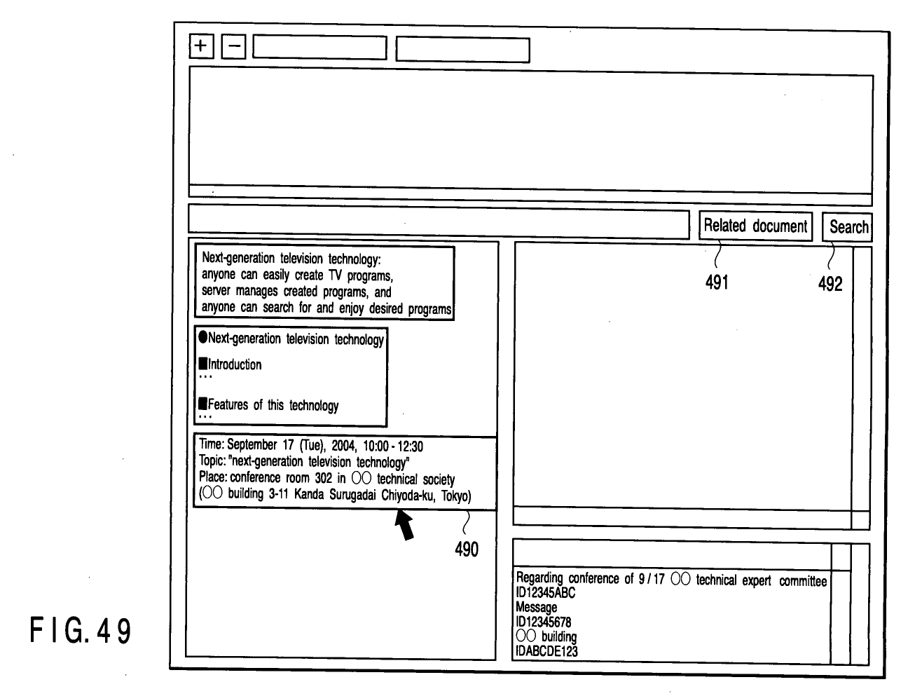

While a plurality of scrap sheets are generated in the above manner, many related documents can be retrieved by using scrap sheets and event sequence on the basis of a given document or componentized document. As shown in FIG. 49, the user selects one componentized document 490 in the scrap sheet, switches a search strategy 491 to “related document”, and presses a search button 492. This makes it possible to search for the related document. According to this related document search, the user can search for an original document of a componentized document, a scrap sheet including a componentized document, another componentized document which a scrap sheet including the componentized document includes, an original document of another componentized document which a scrap sheet including the componentized document includes, and the like.

It is also preferable that in this search, with regard to an event in which a document is referred to, a document which is referred to by a given event located near the event on an event sequence is also included as a search target.

As has been described above, by using event information and a scrap sheet generated in the process of making checks before a conference, the user can easily refer to the scrap sheet again, display information about work which an event associated with a componentized document in the scrap sheet has, and resume related work from the display operation.

According to the embodiment described above, pieces of event information associated with events in which the document search unit 3 searches for a document, the document display unit 5 displays a document, the componentization unit 6 componentizes a document, and the scrap sheet unit 7 performs scrap processing can be stored and managed. Using these pieces of event information makes it possible to, for example, improve the efficiency of event filtering under various conditions, browsing of an event sequence upon simplification of the event sequence at various granularities, and search processing of reference documents in events.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information management apparatus that manages information for displaying on a display device, comprising:
an event generation device configured to generate a plurality of events each including work information of a work having a work type and time information indicating at least when the work was done;
an event storage device to store the plurality of events generated by the event generation device;
an event display control device connectable to the display device, and configured to arrange the plurality of events in an order corresponding to their time information, and to control the display device to display the events in different display forms in accordance with the work type;
an event selection device configured to select an event from the plurality of events displayed by the display device controlled by the event display control device; and
an information display control device connectable to the display device and configured to control the display device to display the work information which the selected event has.

2. An apparatus according to claim 1, wherein the work information includes at least one of:
a search query for a search for a document,
a location of a search result document,
a location of a display document,
a componentized document formed from part of a document, and
a scrap sheet comprising a componentized document.

3. An apparatus according to claim 1, wherein the event display control device controls the display device to display, together with the event, at least one of the work information, the time information, and the work type.

4. An apparatus according to claim 1, further comprising:
an extraction device configured to extract some of the plurality of events stored in the event storage device, and wherein the event display control device controls the display device to display some events extracted by the extraction device.

5. An apparatus according to claim 4, wherein the event display control device comprises an event display control object including at least one of a scroll bar for adjusting a time interval of an event, a button for adjusting a granularity of event display, and a context menu for selecting a prepared extraction condition.

6. An apparatus according to claim 5, wherein the extraction device extracts an event corresponding to a time interval specified by the scroll bar, an event which is simplified in accordance with a granularity designated by the granularity adjustment button, and an event which satisfies the extraction condition of the context menu, in accordance with an instruction from the event display control object.

7. An apparatus according to claim 5, wherein the event display control object is displayed while being superimposed on an event or work information.

8. An apparatus according to claim 5, wherein the extraction device extracts information associated with past work so as to satisfy one or a combination of an extraction condition for information associated with the work and an extraction condition for meta-information of the work which comprises the time information indicating when the work was done and the work type.

9. An apparatus according to claim 1, wherein the information display control device includes at least one of:
a search query input device configured to input a search query for a document search,
a document search device configured to execute a document search on the basis of a search query,
a search result display device to display a list of retrieved documents,
a document display device to display a content of a retrieved document,
a componentization device configured to componentized part of a content of a document, and
a scrap sheet device configured to perform scrap processing of a componentized document.

10. An apparatus according to claim 9, wherein the event generation device generates at least one of search-type event information representing a record of searches executed by the document search device, display-type event information representing a record of document content display performed by the document display device, componentization-type event information representing a record of componentization processing by the componentization device, and scrap-type event information representing a record of scrap processing by the scrap sheet device.

11. An apparatus according to claim 9, wherein the event display control device controls the display device to perform one of operations of giving the search query input device a search query for a document search, making the search result display device display a list of search result documents, making the document display device display a content of a retrieved document, and making the scrap sheet device read in a componentized document which forms a scrap sheet.

12. An apparatus according to claim 1, wherein the event storage device includes a relational database management system.

13. An apparatus according to claim 3, wherein the extraction device sets, as an event filtering condition, at least one of a time interval of an event as a display target, a granularity of event display, a type of event, a reference to a document which an event has, and a reference to a componentized document which an event has.

14. An information management method comprising:
generating a plurality of events each including work information of a work having a work type and time information indicating at least when the work was done;
storing the generated plurality of events;
arranging the plurality of events in an order corresponding to their time information, and displaying the events in different display forms in accordance with the work type;
selecting an event from the displayed plurality of events; and
displaying the work information which the selected event has.

15. An information management program stored in a computer readable medium for managing information for displaying on a display device, the program comprising:
means for instructing a computer to generate a plurality of events each including work information of a work having a work type and time information indicating at least when the work was done;
means for instructing the computer to store the generated plurality of events;
means for instructing the computer to arrange the plurality of events in an order corresponding to their time information, and display the events in different display forms in accordance with the work type;
means for instructing the computer to select an event from the displayed plurality of events; and
means for instructing the computer to display the work information which the selected event has.
